(19) United States
(12) Patent Application Publication
(10) Pub. No.: US 2026/0284636 A1
(43) Pub. Date: Sep. 24, 2026

(54) COMPOSITE RESINS FOR SELECTIVE GERMANIUM REMOVAL FROM AQUEOUS SOLUTIONS

(71) Applicant: Advanced Isotope Technologies, LLC, Mobile, AL (US)

(72) Inventor: Shameem Hasan, Sunrise, FL (US)

(73) Assignee: Advanced Isotope Technologies, LLC, Mobile, AL (US)

(21) Appl. No.: 19/550,162

(22) Filed: Feb. 25, 2026

Related U.S. Application Data
(60) Provisional application No. 63/762,872, filed on Feb. 25, 2025.

(51) Int. Cl. B01J 20/22; B01J 20/02; B01J 20/28; B01J 20/30; C02F 1/28; C02F 101/10

(52) U.S. Cl. CPC B01J 20/22; B01J 20/0251; B01J 20/027; B01J 20/28026; B01J 20/3078; C02F 1/288; C02F 1/281; C02F 1/285; C02F 2101/10

(57) ABSTRACT

A mesoporous boron-based composite material for selective germanium removal from aqueous solutions is provided. The mesoporous boron-based composite material comprises a boron-containing matrix derived from boric acid, a nitrogen-containing component derived from melamine incorporated into the boron-containing matrix, and a metal dopant comprising tin dispersed within the boron-containing matrix. The composite material exhibits selective adsorption of germanium over gallium from acidic aqueous solutions. The composite material may be calcined at a temperature ranging from 500° C. to 600° C. under a nitrogen environment. The tin may be derived from stannous chloride. The composite material may further comprise a surfactant template derived from a triblock copolymer such as Pluronic-123. The composite material exhibits a germanium uptake capacity of at least 1.0 mg Ge per gram of composite material from a 0.05 M hydrochloric acid solution while exhibiting substantially no gallium uptake.

### CROSS-REFERENCE TO RELATED APPLICATIONS

This application claims priority to U.S. Provisional Patent Application No. 63/762,872, filed Feb. 25, 2025, which is hereby incorporated by reference.

### FIELD OF INVENTION

The present disclosure relates to composite resins for selective germanium removal from aqueous solutions.

### BACKGROUND

Radionuclides that emit positrons have received considerable attention in nuclear medicine due to their ability to interact with soft tissue matter and their application in molecular imaging techniques. Gallium-68 (Ga-68) represents a positron emitter radionuclide that is widely used for positron emission tomography (PET), which serves as a functional molecular imaging tool in biological research and medical diagnosis. Ga-68 can be obtained from the electron capture decay of Germanium-68 (Ge-68), which has a half-life of approximately 270.95 days and exists in secular equilibrium with its daughter Ga-68 having a half-life of approximately 68 minutes. The growing use of Ge-68/Ga-68 generators for radiopharmaceutical purposes has increased the demand for materials capable of selectively separating these radionuclides. A generator system typically comprises a self-contained apparatus housing a parent/daughter radionuclide mixture in equilibrium, where modern commercial generators consist of a chromatographic column situated within a shielding container. In such generator systems, Ge-68 is bound to an ion exchange material, and over time, Ge-68 decays to Ga-68, which is subsequently eluted from the column using dilute hydrochloric acid solution for use in developing targeted PET radiopharmaceuticals.

Modern commercially available Ge-68/Ga-68 generators utilize solid phase matrices such as titanium dioxide, silicon dioxide, cerium dioxide, or tin dioxide to provide gallium-68 chloride by elution with dilute hydrochloric acid while the parent Ge-68 radionuclide remains on the matrix. Titanium dioxide has been considered as a suitable material for various applications due to its oxidation strength, low cost, non-toxicity, and chemical stability against photo corrosion and chemical corrosion. Titanium dioxide crystals exist in anatase, rutile, and brookite phases, where rutile represents the most stable phase while anatase is metastable at room temperature. Metal doping in the metastable anatase phase can modify the crystal structure of titania at lower temperatures and cause a transformation to the rutile phase, providing a stabilized phase of titania. However, existing solid phase matrices may experience challenges related to germanium uptake capacity, selectivity between germanium and gallium, and stability under acidic conditions during repeated elution cycles. The performance of these materials in generator applications depends upon mass transfer to active surface sites, charge transfer at the metal oxide surface, and charge or ion transport in the bulk of the material.

Mesoporous metal oxides are widely used in various industrial applications due to their electronic, redox, and magnetic properties, yet their application in radionuclide generator systems presents particular challenges. Materials used in Ge-68/Ga-68 generators face exposure to radiation and acidic conditions over extended periods, which can lead to degradation of the adsorbent material and potential release of metallic impurities into the eluate. The presence of metallic impurities in the gallium-68 eluate is undesirable for radiopharmaceutical applications, as such impurities may interfere with radiolabeling processes or introduce unwanted substances into pharmaceutical preparations. Additionally, achieving selective adsorption of germanium while allowing efficient elution of gallium presents a technical challenge, as both elements may interact with adsorbent surfaces through similar mechanisms. Boron-based materials such as boron nitride possess physical and chemical properties including thermal conductivity, surface area, chemical stability, and oxidation resistance that may be relevant to adsorbent applications. The development of adsorbent materials that can withstand radiation exposure and extreme pH conditions without substantial physical degradation while maintaining selectivity for germanium over gallium remains an area of ongoing interest.

Current approaches to preparing adsorbent materials for germanium removal from aqueous solutions involve various synthesis techniques including sol-gel methods and hydrothermal treatments. The calcination temperature and composition of metal-doped oxide materials can affect the crystalline phase of the material, which in turn influences adsorption performance characteristics. For example, doping of titania with metal ions can create charge compensating anion vacancies and cause transformation to more stable crystalline phases. The modification of metal oxide surfaces with organic functional groups represents another approach to enhancing adsorption capacity and selectivity, where compounds containing oxygen-containing organic ligands such as catechol can form complexes with germanium. Crosslinking agents and amine-containing compounds have been used to create functional polymeric networks on adsorbent surfaces through various reaction mechanisms including Michael addition and Schiff base reactions. The preparation of adsorbent materials that combine the stability of inorganic metal oxide matrices with the selectivity provided by organic functional groups continues to be explored for applications in radionuclide separation and other fields requiring selective removal of germanium from aqueous solutions.

Accordingly, there is a need in the art for composite resins exhibiting improved selective germanium removal from aqueous solutions.

### SUMMARY

A composite resin and method for selective germanium removal from aqueous solutions is provided. In one aspect, the present disclosure is a mesoporous boron-based composite material comprising a boron-containing matrix derived from boric acid, a nitrogen-containing component derived from melamine, and a metal dopant comprising tin for selective adsorption of germanium over gallium from acidic aqueous solutions. In another aspect, the present disclosure is a method of preparing a mesoporous boron-based composite material through surfactant-templated synthesis and calcination. In yet another aspect, the present disclosure enables selective removal of germanium from aqueous solutions containing both germanium and gallium, such as those encountered in Ge-68/Ga-68 radionuclide generator systems. In still another aspect, the present disclosure provides a mesoporous titanium-based composite material comprising a titanium dioxide matrix with a metal dopant and organic functional groups for selective germanium adsorption. Generally, the present disclosure relates to composite materials that exhibit selective adsorption of germanium while allowing gallium to remain substantially in solution, enabling separation of these elements for radiopharmaceutical and other applications.

In an embodiment, a mesoporous titanium-based composite material and method for selective germanium removal from aqueous solutions is provided. The composite material includes a titanium dioxide matrix with a metal dopant dispersed therein. An organic functional group is attached to the titanium dioxide matrix. The composite material exhibits selective adsorption of germanium over gallium from acidic aqueous solutions. The titanium dioxide matrix may comprise various crystalline phases and the composite material may be calcined at elevated temperatures. The method includes dissolving a surfactant in a solvent, adding a titanium precursor and a metal dopant, processing the mixture to form a gel, drying the gel, and calcining the dried gel at elevated temperatures to obtain the mesoporous titanium-based composite material.

In another embodiment, a mesoporous boron-based composite material and method for selective germanium removal from aqueous solutions is provided. The composite material includes a boron-containing matrix that may be derived from a boron source. The composite material further includes a nitrogen-containing component incorporated into the boron-containing matrix. A metal dopant may be dispersed within the boron-containing matrix. The composite material exhibits selective adsorption of germanium over gallium from acidic aqueous solutions. The composite material may be calcined at elevated temperatures and may further comprise a surfactant template. The method includes dissolving a surfactant in a solvent to form a surfactant solution. A boron source is added to the surfactant solution. A nitrogen-containing solution is prepared and combined with the boron-surfactant solution. The combined mixture is processed to form a gel, which is subsequently dried. The dried material is calcined at elevated temperatures to obtain the mesoporous boron-based composite material, and a metal dopant may be added during the preparation process.

According to another aspect of the present disclosure, a method of selectively removing germanium from an aqueous solution containing germanium and gallium is provided. The method includes contacting the aqueous solution with a mesoporous composite material comprising either a boron-containing matrix with a nitrogen-containing component and a metal dopant, or a titanium dioxide matrix with a metal dopant and an organic functional group. Germanium is adsorbed onto the mesoporous composite material while gallium remains substantially in the aqueous solution. The aqueous solution is separated from the mesoporous composite material to obtain a germanium-depleted solution. The aqueous solution may comprise an acidic solution. The mesoporous composite material may be calcined at elevated temperatures and exhibits selective germanium uptake while exhibiting reduced gallium uptake from the aqueous solution.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other systems for carrying out the same purpose of the system and method disclosed herein. Those skilled in the pertinent art should also realize that such equivalent designs or modifications do not depart from the scope of the system and method of the present disclosure. Further, it should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF FIGURES

Non-limiting and non-exhaustive examples are described with reference to the following figures.

FIG. 1 depicts a chemical reaction mechanism diagram illustrating oxidation of catechol to quinone and crosslinking with tetraethylpentamine, according to aspects of the present disclosure.

FIG. 2 depicts a graph showing dynamic uptake of germanium from a column packed with TG resin, according to an embodiment.

FIG. 3A depicts a graph illustrating dynamic uptake of germanium and gallium from a column packed with TSN resin, according to aspects of the present disclosure.

FIG. 3B depicts a graph illustrating dynamic uptake of germanium and gallium from a column packed with TSN resin, according to aspects of the present disclosure.

FIG. 3C depicts a graph illustrating dynamic uptake of germanium and gallium from a column packed with TSN resin, according to aspects of the present disclosure.

FIG. 4 illustrates a flowchart for a method of preparing a TG mesoporous composite resin, according to an embodiment.

FIG. 5 illustrates a flowchart for a method of preparing a TSN activated composite resin, according to aspects of the present disclosure.

FIG. 6 illustrates a flowchart for a method of preparing a TSN-CP crosslinked composite resin, according to an embodiment.

FIG. 7 illustrates a flowchart for a method of preparing BP and BPS mesoporous composite resins, according to aspects of the present disclosure.

FIG. 8 illustrates a flowchart for a method of preparing a BM mesoporous composite resin, according to an embodiment.

FIG. 9 illustrates a flowchart for a method of preparing a BMS mesoporous composite resin, according to aspects of the present disclosure.

FIG. 10A illustrates a schematic diagram of possible Ge-68/Ga-68 generator system configurations using mesoporous metal-infused resin for selective germanium removal from aqueous solutions, according to an embodiment.

FIG. 10B illustrates a table presenting data for germanium and gallium uptake onto TG resin from 0.05 M HCl solution, according to an embodiment.

FIG. 10C illustrates a table presenting data for germanium and gallium uptake onto various titanium-based composite resins from 0.05 M HCl solution, according to an embodiment.

FIG. 10D illustrates a table presenting data for germanium and gallium uptake onto various boron-based composite resins from 0.05 M HCl solution, according to an embodiment.

FIG. 10E illustrates a table presenting constants of the Langmuir equation for germanium adsorption on TSN and TBN composites, according to an embodiment.

FIG. 10F illustrates a table presenting data for Germanium-68 uptake onto boron-based BMS-600 resin in a dynamic process, according to an embodiment.

FIG. 10G illustrates a table presenting data for Germanium-68 uptake onto titanium-based TSN-600 resin in a dynamic process, according to an embodiment.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally. The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components. As defined herein, the word substantial means more than half of the length.

The present disclosure relates to mesoporous composite resin materials for the selective removal of germanium from aqueous solutions, with particular application to Ge-68/Ga-68 radionuclide generator systems used in positron emission tomography (PET) imaging. In a preferred embodiment, the composite resin materials include both titanium-based and boron-based variants that exhibit selective adsorption of germanium ions over gallium ions from acidic aqueous solutions. The radionuclide Ga-68 serves as a positron emitter that may be obtained from the electron capture decay of Ge-68, which has a half-life of approximately 270.95 days and exists in secular equilibrium with its daughter Ga-68 having a half-life of approximately 68 minutes. In some preferred embodiments, a mesoporous boron-based composite material for selective germanium removal from aqueous solutions may be employed in generator systems where Ge-68 is bound to an ion exchange resin and Ga-68 is subsequently eluted using dilute hydrochloric acid solution. The eluted Ga-68, in the form of gallium chloride, may then be used for the development of targeted PET radiopharmaceuticals. In another preferred embodiment, a mesoporous titanium-based composite material for selective germanium removal from aqueous solutions may be utilized as an alternative matrix material for such generator applications.

The composite resin materials described herein exhibit resistance to high radiation exposure and resistance to extreme pH conditions and temperatures without substantial physical degradation of the composite resin structure. In a preferred embodiment, the mesoporous boron-based composite material includes a boron-containing matrix derived from boric acid, a nitrogen-containing component derived from melamine incorporated into the boron-containing matrix, and a metal dopant comprising tin dispersed within the boron-containing matrix. In some preferred embodiments, the mesoporous titanium-based composite material includes a titanium dioxide matrix, a metal dopant dispersed within the titanium dioxide matrix, and an organic functional group attached to the titanium dioxide matrix. The titanium-based materials may utilize titanium dioxide in various crystalline phases, including anatase and rutile phases, where metal doping in the metastable anatase phase may modify the crystal structure and cause a transformation to the more stable rutile phase. In another preferred embodiment, the boron-based materials may incorporate phosphorus or organic nitrogen compounds with tin to provide sorption surface sites for germanium ions. The mesoporous structure of these composite materials provides active surface sites that facilitate mass transfer and charge transfer during the adsorption process.

The selective adsorption characteristics of the composite resin materials arise from the interaction between germanium cations and the oxide or functional group surfaces of the composite matrices. In a preferred embodiment, germanium in aqueous solution may exist as Ge⁴⁺ at pH values below 2.0, and the germanium cation is adsorbed onto the oxide surface of the composite through interaction with hydrogen bonding sites. In some preferred embodiments, gallium ions, which are considered hard acids, interact more strongly with highly ionic, non-polarizable Lewis bases compared to the oxide surfaces of the composite materials, resulting in minimal gallium adsorption onto the titanium-based and tin-doped boron-based resins. The mesoporous boron-based composite material for selective germanium removal from aqueous solutions may exhibit a germanium uptake capacity of at least 1.0 mg Ge per gram of composite material from a 0.05 M hydrochloric acid solution while exhibiting substantially no gallium uptake. In another preferred embodiment, the mesoporous titanium-based composite material for selective germanium removal from aqueous solutions may exhibit similar selective adsorption behavior when the titanium dioxide matrix is modified with appropriate metal dopants and organic functional groups. The oxidation of tin species (Sn²⁺/Sn⁴⁺) in the activated composite matrices may convert lower valence metallic ions to higher valence states, thereby facilitating selective adsorption of germanium over gallium.

The composite resin materials may be prepared using sol-gel and hydrothermal techniques, where the size, stability, and morphology of the sol depend on the solution pH and molar ratio of the components present in the mixture. In a preferred embodiment, the titanium-based composite materials may be prepared by the hydrolysis and condensation reaction of titanium alkoxide precursors with various building blocks including glucose or ethylene glycol. In some preferred embodiments, the boron-based composite materials may be prepared by combining boric acid with phosphate compounds or melamine in the presence of surfactant templates such as triblock copolymer Pluronic-123. The activation of these composite materials may be carried out using several stages of washing, drying, and heat treatment at temperatures ranging from 450° C. to 900° C. depending on the specific composite formulation. In another preferred embodiment, the calcination temperature and composition of the composite materials may be established based on the amount of germanium and gallium uptake onto the resin from aqueous solutions and the amount of metallic component release from the resin to the solution during the metal ion uptake process. The multiple stages of heating, washing, drying, and cooling may remove unreacted components as impurities from the matrix and produce activated composite materials with enhanced germanium selectivity and stability in acidic environments.

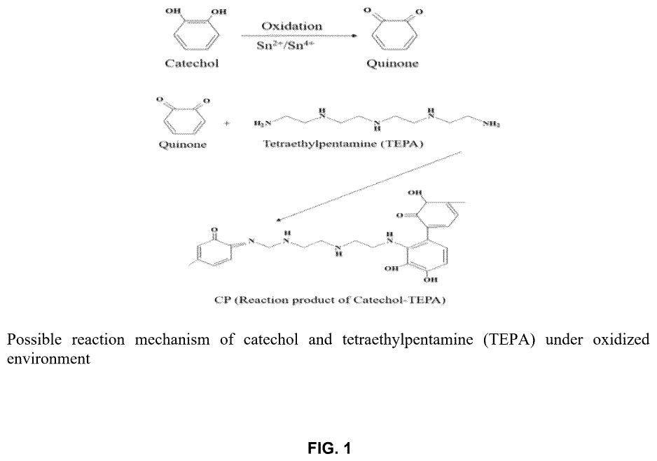

As illustrated in FIG. 1, oxidation of catechol to quinone and subsequent crosslinking with tetraethylpentamine (TEPA) may be used to form the TSN-CP composite material. In a preferred embodiment, catechol, which is also known as 1,2-dihydroxybenzene, is depicted in the upper portion of the diagram as a benzene ring with two adjacent hydroxyl groups (OH) that serve as oxygen-containing organic ligands capable of forming complexes with germanium ions. The presence of tin species (Sn²⁺/Sn⁴⁺) in the activated TSN-600 matrix promotes oxidation of catechol to form reactive quinone groups, as shown by the oxidation reaction arrow in the diagram. In some preferred embodiments, the quinone product is depicted as a six-membered ring with two carbonyl groups (O) replacing the hydroxyl groups of the catechol precursor. The oxidation reaction facilitated by the tin dopant converts the catechol hydroxyl groups to carbonyl groups, thereby generating electrophilic sites on the quinone ring that are reactive toward nucleophilic amine groups. As illustrated in FIG. 1, the metal dopant comprising tin dispersed within the matrix serves as an oxidation promoter that enables the formation of the reactive quinone intermediate.

The middle portion of the diagram shows the quinone intermediate reacting with tetraethylpentamine (TEPA), which serves as a source of amine groups that participate in the crosslinking reaction. In a preferred embodiment, TEPA is illustrated as a linear molecule containing five nitrogen atoms connected by ethylene bridges, with terminal primary amine groups (NH₂) and secondary amine groups (NH) along the chain. The amine groups of TEPA function as nucleophiles that attack the electrophilic carbonyl carbons of the quinone through Michael addition reactions, forming covalent bonds between the aromatic quinone ring and the polyamine backbone. In some preferred embodiments, the primary amine groups at the terminal positions of TEPA may also react with the carbonyl groups through Schiff base reactions, forming imine bonds (C═N) that further stabilize the crosslinked network structure. The combination of Michael addition and Schiff base reactions provides multiple bonding pathways between the catechol-derived quinone species and the TEPA molecules, resulting in a robust crosslinked polymer network. In another preferred embodiment, the organic functional group attached to the titanium dioxide matrix comprises a catechol-containing compound that participates in these crosslinking reactions to enhance germanium uptake capacity.

The lower portion of the diagram depicts the final crosslinked CP (Catechol-TEPA) reaction product that forms the functional coating on the TSN-600 composite surface. In a preferred embodiment, the CP product structure displays a complex arrangement where aromatic rings from catechol and quinone are connected through the TEPA backbone via nitrogen linkages, with the structure exhibiting hydroxyl groups, carbonyl groups, and imine bonds formed through the Michael addition and Schiff base reactions. The crosslinked TSN-CP composite exhibits anionic functional groups on its surface sites due to the catechol-TEPA network, which facilitates selective adsorption of cationic germanium species through Coulombic interactions. In some preferred embodiments, the aromatic rings in the CP product show various states of oxidation, including catechol moieties with adjacent hydroxyl groups and quinone moieties with carbonyl groups, providing multiple binding sites for germanium ions. The composite material exhibits selective adsorption of germanium over gallium from acidic aqueous solutions because the anionic surface sites preferentially attract the cationic germanium species while the gallium ions, which form negatively charged chloride complexes in hydrochloric acid solutions, are not retained by the anionic surface. In another preferred embodiment, the uniform distribution of the catechol-TEPA reaction product onto the activated TSN-600 matrix improves mass transfer properties of the final resin product while preventing metal ion dissolution from the matrix in highly acidic solution conditions.

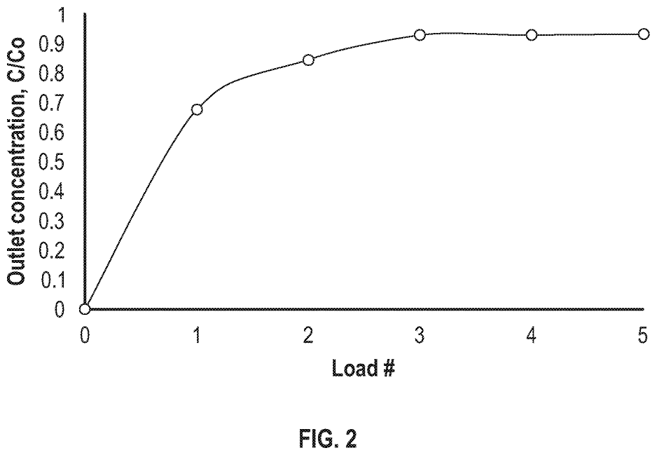

Referring to FIG. 2, a graph illustrates the dynamic uptake of germanium from a column packed with TG resin, depicting the breakthrough curve that characterizes the adsorption behavior under continuous flow conditions. In a preferred embodiment, the dynamic study uses an all-glass column with approximately 1 cm³ bed volume packed with composite resin for continuous germanium uptake, where the bed volume is calculated from the expression πr²h with r representing the radius of the column and h representing the bed height. The vertical axis of the graph displays the outlet concentration ratio C/C₀, ranging from 0 to 1, where C represents the outlet concentration and C₀ represents the initial inlet concentration of germanium in the feed solution. In some preferred embodiments, the horizontal axis displays the load number ranging from 0 to 5, which corresponds to successive volumes of feed solution passed through the column during the dynamic adsorption experiment. The experimental conditions for the dynamic study include an amount of TG-9 resin in the column of 0.509 gram, an initial concentration of germanium of 74.64 mg Ge/L, an initial concentration of gallium of 100 mg Ga/L, an acid concentration of 0.05 M HCl, and a flow rate of 1 mL/min. As illustrated in FIG. 2, the dynamic study operates at an inlet flow rate of 1.0 mL/min through the resin bed for germanium adsorption, which allows sufficient contact time between the feed solution and the composite resin material.

With continued reference to FIG. 2, the graph includes data points connected by a smooth curve that illustrates the characteristic breakthrough behavior of germanium adsorption on the TG resin column. In a preferred embodiment, the curve begins at approximately zero at load number 0, indicating that the column initially retains substantially all of the germanium from the feed solution during the early stages of the dynamic adsorption process. The curve rises sharply between load numbers 0 and 1 to reach approximately 0.68, demonstrating that the resin bed begins to approach saturation as more germanium-containing solution passes through the column. In some preferred embodiments, the curve continues to increase more gradually through load number 2 to approximately 0.84, and approaches saturation around load number 3 at approximately 0.93, indicating that the available adsorption sites on the TG resin are becoming progressively occupied by germanium ions. The curve plateaus at approximately 0.93 to 0.95 through load numbers 4 and 5, signifying that the column has reached near-complete saturation and the outlet concentration approaches the inlet concentration. In another preferred embodiment, the dynamic study with TG-9 resin retains a net 80 μg Ge/g of resin from a solution containing 74.64 mg/L Ge and 100 mg/L Ga in 0.05 M HCl, demonstrating the selective germanium adsorption capacity of the titanium-based composite material.

The dynamic adsorption experiment depicted in FIG. 2 demonstrates the selective removal of germanium from an aqueous solution containing both germanium and gallium ions under continuous flow conditions. In a preferred embodiment, the column was rinsed with 10 mL deionized water and 10 mL of 0.05 M HCl solution after the loading phase, and the rinsed solution was analyzed for any germanium release from the column to determine the net retention. The batch adsorption experiments that complement the dynamic studies use 80 mg of resin per 8 mL of solution with initial concentrations of 100-200 mg/L Ge and Ga in 0.05 M HCl, providing equilibrium adsorption data that characterize the uptake capacity of the composite materials. In some preferred embodiments, the batch adsorption experiments maintain solutions in a shaker at 100 rpm for predetermined time at 25° C. (298 K), allowing the system to reach equilibrium conditions for accurate determination of adsorption capacity. The germanium and gallium concentrations are analyzed using Inductively Coupled Plasma (ICP) Agilent 7700X equipped with mass spectroscopy, which provides accurate quantification of both metal ions in the solution phase before and after contact with the composite resin. As illustrated in FIG. 2, no gallium uptake was observed during the dynamic study, confirming that the TG resin exhibits selective adsorption of germanium over gallium from the acidic aqueous solution.

The dynamic adsorption results shown in FIG. 2 provide support for a method of selectively removing germanium from an aqueous solution containing germanium and gallium using the mesoporous composite materials described herein. In a preferred embodiment, the method comprises contacting the aqueous solution with a mesoporous composite material, adsorbing germanium onto the mesoporous composite material while gallium remains substantially in the aqueous solution, and separating the aqueous solution from the mesoporous composite material to obtain a germanium-depleted solution. As described previously, a mesoporous boron-based composite material comprising a boron-containing matrix, a nitrogen-containing component derived from melamine, and a tin dopant may be employed in similar dynamic adsorption configurations to achieve selective germanium removal. In some preferred embodiments, the aqueous solution comprises a 0.05 M hydrochloric acid solution, which corresponds to the acid concentration used in the dynamic study depicted in FIG. 2 and provides the appropriate pH conditions for selective germanium adsorption. The breakthrough curve behavior observed in FIG. 2 demonstrates that the composite resin materials may be effectively utilized in column configurations for continuous processing of germanium-containing solutions. In another preferred embodiment, the dynamic adsorption approach allows for the selective retention of germanium ions while gallium ions pass through the column substantially unretained, enabling efficient separation of these two elements from mixed aqueous solutions.

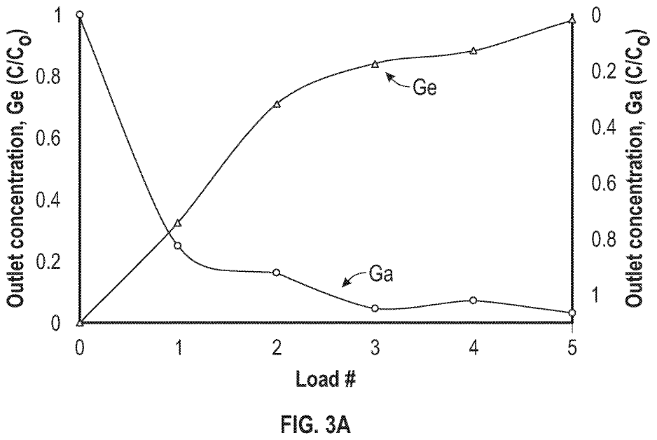

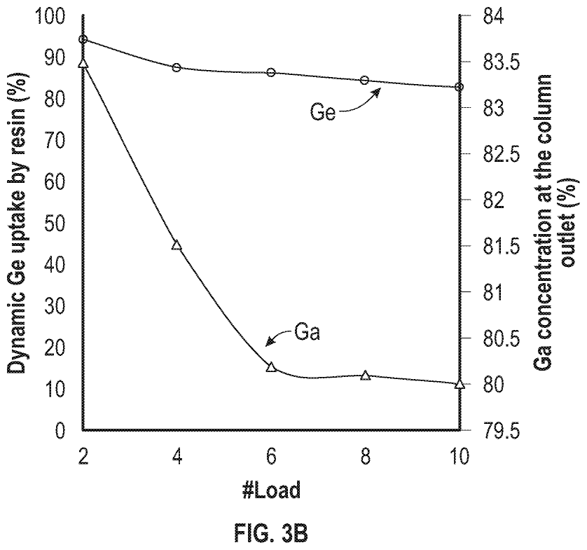

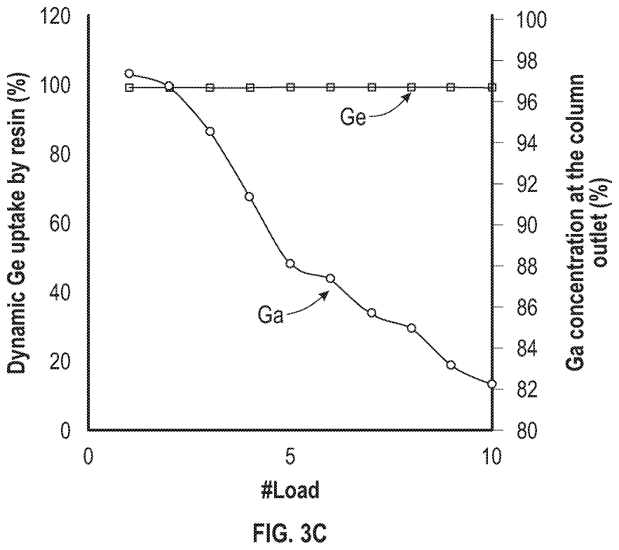

Referring to FIG. 3A, a dual-axis line graph illustrates the dynamic uptake of germanium and gallium from a column packed with TSN-600 resin, demonstrating the selective adsorption characteristics of the tin-doped titanium composite material under continuous flow conditions. In a preferred embodiment, the left vertical axis displays the outlet concentration ratio for germanium expressed as C/C₀ ranging from 0 to 1, where C represents the outlet concentration and C₀ represents the initial inlet concentration of germanium in the feed solution. The right vertical axis displays the outlet concentration ratio for gallium expressed as C/C₀ with an inverted scale ranging from 0 at the top to 1 at the bottom, which allows for visual comparison of the contrasting adsorption behaviors of the two metal ions. In some preferred embodiments, the horizontal axis displays the load number ranging from 0 to 5, corresponding to successive volumes of feed solution passed through the column during the dynamic adsorption experiment. The experimental conditions specified in FIG. 3A indicate that the column contained 0.2 gram of TSN-600 resin, the initial concentration of germanium was 54 mg Ge/L, the initial concentration of gallium was 100 mg Ga/L, the acid concentration of the solution was 0.05 M HCl, and the flow rate was 1 mL/min. As illustrated in FIG. 3A, the dynamic study with TSN-600 resin demonstrates the selective separation of germanium from gallium under conditions representative of those used in Ge-68/Ga-68 generator applications.

With continued reference to FIG. 3A, the germanium curve shows a decreasing trend from approximately 1.0 at load 0, declining through intermediate values at loads 1 through 4, and reaching approximately 0.2 at load 5, indicating increasing retention of germanium by the TSN-600 resin over successive loads. In a preferred embodiment, the decreasing outlet concentration ratio for germanium demonstrates that the TSN-600 composite material progressively adsorbs germanium ions from the feed solution as the dynamic adsorption process continues, with the resin bed retaining an increasing fraction of the incoming germanium. The germanium curve behavior indicates that the TSN-600 resin exhibits favorable adsorption kinetics for germanium ions, with the outlet concentration decreasing as the resin bed accumulates germanium from the continuous feed stream. In some preferred embodiments, the bed appears to approach saturation after approximately 10 minutes of operation, as indicated by the stabilization of the outlet germanium concentration at the lower values observed at load numbers 4 and 5. The dynamic study with TSN-600 resin retains 687 μg Ge/g of resin from a solution containing 54 mg/L Ge and 100 mg/L Ga in 0.05 M HCl, demonstrating the germanium uptake capacity of the tin-doped titanium composite material under continuous flow conditions. In another preferred embodiment, the column was rinsed with 10 mL deionized water after the loading phase, and the rinsed solution was analyzed to determine the net germanium retention by the TSN-600 resin bed.

As illustrated in FIG. 3A, the gallium curve remains relatively stable near 0 on the right vertical axis throughout the loading sequence, indicating that gallium passes through the column with minimal retention by the TSN-600 resin. In a preferred embodiment, the stable gallium curve demonstrates that the TSN-600 composite material does not adsorb gallium ions from the feed solution, allowing the gallium to pass through the column substantially unretained while germanium is selectively adsorbed. The dynamic study with TSN-600 resin rejects greater than 97.58% of the gallium present in the feed solution, confirming the selective adsorption characteristics of the tin-doped titanium composite material for germanium over gallium. In some preferred embodiments, the gallium ions form negatively charged tetrachlorogallate complexes [GaCl₄]⁻ in the 0.05 M HCl solution, which are not adsorbed by the oxide surface sites of the TSN-600 composite and therefore pass through the column in the effluent stream. The contrasting behavior of the germanium and gallium curves in FIG. 3A provides visual evidence of the selectivity characteristics that make the TSN-600 composite material suitable for Ge-68/Ga-68 generator applications where selective retention of the parent Ge-68 radionuclide is desired while the daughter Ga-68 is eluted for radiopharmaceutical use. In another preferred embodiment, by adjusting the bed volume or the amount of resin in the bed, a desired amount of germanium may be held selectively in a column from an aqueous solution of 0.05 M HCl while gallium passes through substantially unretained.

The selectivity characteristics demonstrated in FIG. 3A support the use of mesoporous composite materials for methods of selectively removing germanium from aqueous solutions containing both germanium and gallium ions. In a preferred embodiment, the method comprises contacting the aqueous solution with a mesoporous composite material, adsorbing germanium onto the mesoporous composite material while gallium remains substantially in the aqueous solution, and separating the aqueous solution from the mesoporous composite material to obtain a germanium-depleted solution. As described previously, a mesoporous boron-based composite material comprising a boron-containing matrix, a nitrogen-containing component derived from melamine, and a tin dopant may be employed in similar dynamic adsorption configurations to achieve selective germanium removal with comparable selectivity characteristics. In some preferred embodiments, the mesoporous boron-based composite material is calcined at a temperature ranging from 500° C. to 600° C. under a nitrogen environment to develop the mesoporous structure and active surface sites for germanium adsorption. The mesoporous boron-based composite material exhibits a germanium uptake capacity of at least 1.0 mg Ge per gram of composite material while exhibiting substantially no gallium uptake from the aqueous solution, which is consistent with the selectivity behavior observed for the TSN-600 composite in FIG. 3A. In another preferred embodiment, the aqueous solution comprises a 0.05 M hydrochloric acid solution, which corresponds to the acid concentration used in the dynamic study depicted in FIG. 3A and provides the appropriate pH conditions for selective germanium adsorption over gallium.

Referring to FIG. 3B, a dual-axis graph illustrates the dynamic uptake of germanium from a column packed with approximately 200 mg of TSN-600 resin, demonstrating the selective adsorption characteristics of the tin-doped titanium composite material under continuous flow conditions with extended loading cycles. In a preferred embodiment, the left vertical axis displays the dynamic germanium uptake by resin expressed as a percentage, ranging from 0 to 100 percent, which indicates the fraction of incoming germanium that is retained by the TSN-600 resin bed during each loading cycle. The right vertical axis displays the gallium concentration at the column outlet expressed as a percentage, ranging from 79.5 to 84 percent, which allows for monitoring of the gallium passage through the column during the dynamic adsorption experiment. In some preferred embodiments, the horizontal axis displays the load number ranging from 2 to 10, corresponding to successive volumes of feed solution passed through the column during the extended dynamic adsorption experiment. The experimental conditions specified in FIG. 3B indicate that the column contained approximately 200 mg of TSN-600 resin, the initial concentration of germanium was 84 mg Ge/L, the initial concentration of gallium was 100 mg Ga/L, the acid concentration of the solution was 0.05 M HCl, the flow rate was 1 mL/min, and the exposure time was 0.5 hours. As illustrated in FIG. 3B, the dynamic study with TSN-600 resin demonstrates the progressive saturation behavior of the germanium adsorption sites while gallium passes through the column with minimal retention.

With continued reference to FIG. 3B, the germanium curve shows data points connected by a line, starting at approximately 98 percent uptake at load number 2, decreasing to approximately 90 percent at load number 4, then declining more steeply to approximately 50 percent at load number 6, and continuing to decrease through subsequent load numbers. In a preferred embodiment, the decreasing germanium uptake percentage demonstrates that the TSN-600 composite material progressively approaches saturation as the dynamic adsorption process continues, with the resin bed retaining a decreasing fraction of the incoming germanium as the available adsorption sites become occupied. The germanium curve behavior indicates that the TSN-600 resin exhibits characteristic breakthrough behavior for germanium ions, with the uptake efficiency declining as the resin bed accumulates germanium from the continuous feed stream over extended loading cycles. In some preferred embodiments, the steep decline in germanium uptake between load numbers 4 and 6 indicates that the resin bed is transitioning from the initial high-efficiency adsorption phase to a saturation phase where fewer active sites remain available for germanium binding. The gallium curve shows data points connected by a line with triangular markers, starting at approximately 80 percent concentration at load number 2, increasing slightly to approximately 81 percent at load number 6, and continuing to rise through subsequent load numbers, indicating that gallium passes through the column with minimal retention throughout the extended loading sequence. In another preferred embodiment, the contrasting behavior of the germanium and gallium curves in FIG. 3B provides evidence of the selectivity characteristics that make the TSN-600 composite material suitable for applications requiring selective retention of germanium while allowing gallium to pass through substantially unretained under continuous flow conditions.

Referring to FIG. 3C, a dual-axis graph illustrates the dynamic uptake of germanium from a column packed with approximately 350 mg of TSN-600 resin, demonstrating the selective adsorption characteristics of the tin-doped titanium composite material under continuous flow conditions with an increased resin bed volume compared to the experiments depicted in FIGS. 3A and 3B. In a preferred embodiment, the left vertical axis displays the dynamic germanium uptake by resin expressed as a percentage, ranging from 0 to 120 percent, which indicates the fraction of incoming germanium that is retained by the TSN-600 resin bed during each loading cycle. The right vertical axis displays the gallium concentration at the column outlet expressed as a percentage, ranging from 80 to 100 percent, which allows for monitoring of the gallium passage through the column during the dynamic adsorption experiment. In some preferred embodiments, the horizontal axis displays the load number ranging from 0 to 10, corresponding to successive volumes of feed solution passed through the column during the extended dynamic adsorption experiment. The experimental conditions specified in FIG. 3C indicate that the column contained approximately 350 mg of TSN-600 resin, the initial concentration of germanium was 84 mg Ge/L, the initial concentration of gallium was 100 mg Ga/L, the acid concentration of the solution was 0.05 M HCl, the flow rate was 1 mL/min, and the exposure time was 0.5 hours. As illustrated in FIG. 3C, the increased resin bed volume provides extended germanium adsorption capacity compared to the smaller bed volumes used in the experiments depicted in FIGS. 3A and 3B.

With continued reference to FIG. 3C, the germanium curve indicated by filled circular markers connected by a solid line begins at approximately 100 percent uptake at load number 0 and decreases progressively through the loading sequence, reaching approximately 20 percent uptake by load number 10. In a preferred embodiment, the decreasing germanium uptake percentage demonstrates that the TSN-600 composite material progressively adsorbs germanium from the feed solution as the dynamic adsorption process continues, with the resin bed retaining a decreasing fraction of the incoming germanium as the available adsorption sites become occupied over the extended loading sequence. The germanium curve behavior indicates that the TSN-600 resin exhibits characteristic breakthrough behavior for germanium ions, with the uptake efficiency declining as the resin bed accumulates germanium from the continuous feed stream over the ten loading cycles depicted in the figure. In some preferred embodiments, the gradual decline in germanium uptake from 100 percent at load 0 to approximately 20 percent at load 10 indicates that the larger resin bed volume of 350 mg provides more extended adsorption capacity before saturation compared to the 200 mg bed depicted in FIG. 3B. The progressive saturation behavior observed in FIG. 3C demonstrates that the TSN-600 composite material maintains germanium adsorption activity throughout the extended loading sequence while approaching saturation at higher load numbers. In another preferred embodiment, the germanium uptake data from FIG. 3C may be used to determine the appropriate resin bed volume for specific generator applications based on the desired germanium loading capacity and breakthrough characteristics.

As illustrated in FIG. 3C, the gallium curve indicated by open square markers connected by a solid line remains relatively stable near 98 to 100 percent throughout the loading sequence from load number 0 to load number 10, indicating that gallium passes through the column with minimal retention by the TSN-600 resin. In a preferred embodiment, the stable gallium curve demonstrates that the TSN-600 composite material does not adsorb gallium ions from the feed solution, allowing the gallium to pass through the column substantially unretained while germanium is selectively adsorbed throughout the extended loading sequence. The gallium concentration at the column outlet remains consistently high at approximately 98 to 100 percent of the inlet concentration, confirming that the selectivity characteristics of the TSN-600 composite material are maintained even as the germanium adsorption sites approach saturation. In some preferred embodiments, the contrasting behavior of the germanium and gallium curves in FIG. 3C provides visual evidence of the selectivity characteristics that make the TSN-600 composite material suitable for Ge-68/Ga-68 generator applications where selective retention of the parent Ge-68 radionuclide is desired while the daughter Ga-68 is eluted for radiopharmaceutical use. The data presented in FIG. 3C demonstrates that increasing the resin bed volume from 200 mg to 350 mg extends the germanium adsorption capacity while maintaining the selective rejection of gallium throughout the loading sequence. In another preferred embodiment, the dynamic adsorption results from FIG. 3C support the use of TSN-600 composite material in column configurations where extended germanium loading capacity is desired without compromising the selective elution of gallium for radiopharmaceutical applications.

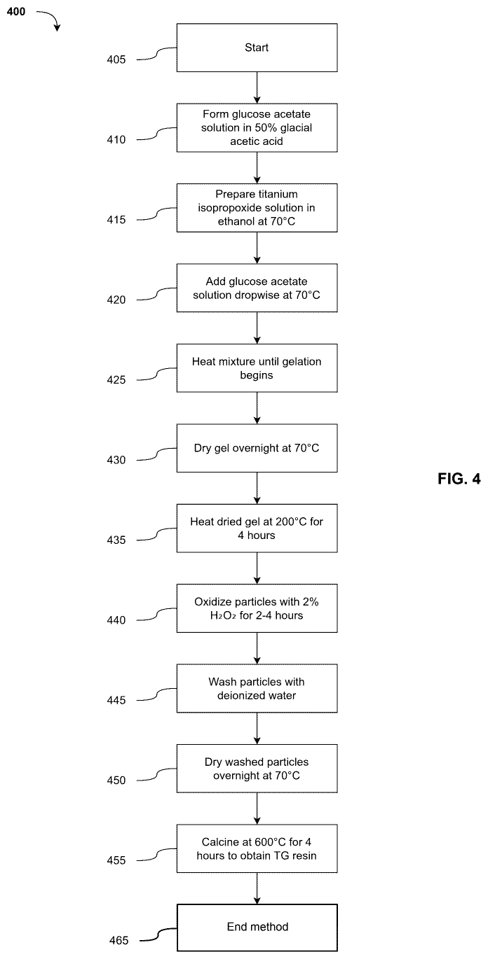

Referring to FIG. 4, a flowchart illustrates a method 400 of preparing a TG mesoporous composite resin for selective germanium removal from aqueous solutions using glucose as a carbon-based building block. In a preferred embodiment, the method 400 begins at step 405, which indicates the beginning of the method 400 for preparing the mesoporous titanium-based composite material through sol-gel synthesis techniques. The method 400 proceeds through sequential processing steps that establish the carbon source, titanium precursor, and thermal treatment conditions for producing the mesoporous composite structure with active surface sites for germanium adsorption. In some preferred embodiments, the method 400 employs glucose as a building block that reacts with acetic acid to form glucose acetate with five acetyl groups in its molecular structure, which serves as the carbon component incorporated into the final titanium oxide matrix. As illustrated in FIG. 4, the method 400 includes steps for forming precursor solutions, gelation, drying, oxidation treatment, washing, and calcination to produce the TG composite resin. In another preferred embodiment, the method 400 produces a mesoporous titanium-based composite material that exhibits selective adsorption of germanium over gallium from acidic aqueous solutions containing 0.05 M hydrochloric acid.

During step 410, a glucose acetate solution may be formed by dissolving a measured quantity of glucose in approximately 6 mL of 50% glacial acetic acid solution. In a preferred embodiment, the reaction between glucose and acetic acid produces glucose acetate having five acetyl groups in its molecular structure, which serves as a carbon-based building block for the composite material that exhibits high chemical stability, low toxicity, and biocompatibility. The glucose acetate solution may be prepared at room temperature with gentle mixing to ensure complete dissolution of the glucose prior to the acetylation reaction proceeding to completion. In some preferred embodiments, the resulting glucose acetate solution may then be set aside for subsequent addition to the titanium-containing mixture prepared in the following step 415. As illustrated in FIG. 4, step 410 establishes the carbon source that will be incorporated into the final mesoporous titanium oxide matrix through the subsequent sol-gel processing steps. In another preferred embodiment, the glucose may be allowed to fully react with the acetic acid before proceeding to subsequent steps to ensure complete formation of the glucose acetate precursor compound.

During step 415, a titanium isopropoxide solution may be prepared separately by adding a measured amount of titanium isopropoxide to 30 mL of ethanol in a beaker under continuous mild stirring and heating at 70° C. (343 K). In a preferred embodiment, the titanium precursor comprises titanium isopropoxide, which serves as the titanium source for the mesoporous titanium-based composite material and undergoes hydrolysis and condensation reactions during the sol-gel process. The mixture may be maintained under continuous stirring and heating conditions until the solution becomes clear and the pH stabilizes, indicating complete dissolution and hydrolysis initiation of the titanium alkoxide precursor. In some preferred embodiments, the molar amounts of titanium, glucose, ethanol, and acetic acid in the final mixture may be 0.021, 0.004, 0.523, and 0.052 mole, respectively, as these ratios were established through optimization to achieve desired mesoporous characteristics. As illustrated in FIG. 4, step 415 prepares the titanium-containing solution that will be combined with the glucose acetate solution from step 410 to form the composite precursor mixture. In another preferred embodiment, the titanium isopropoxide-ethanol solution serves as the primary matrix component for the carbon-doped titanium oxide composite material that will be formed through subsequent gelation and calcination steps.

During step 420, once the titanium isopropoxide-ethanol solution reaches stability, the previously prepared glucose acetate solution may be added dropwise under continuous heating at 70° C. (343 K) and stirring. In a preferred embodiment, the dropwise addition ensures controlled hydrolysis and condensation reactions between the titanium alkoxide and the glucose acetate components, promoting uniform distribution of the carbon source throughout the titanium oxide matrix. The addition rate may be controlled to prevent rapid precipitation and to promote uniform distribution of the carbon source throughout the developing titanium oxide network structure. In some preferred embodiments, the dropwise addition may be performed using a burette or similar precision dispensing apparatus to ensure consistent addition rates and controlled reaction kinetics. As illustrated in FIG. 4, step 420 combines the glucose acetate solution with the titanium isopropoxide solution to initiate the sol-gel polymerization process that forms the composite precursor gel. In another preferred embodiment, the pH and viscosity of the mixture may be monitored during the addition process to ensure proper progression of the hydrolysis and condensation reactions.

During step 425, the combined mixture may be maintained under continuous stirring and heating at 70° C. (343 K) using a water bath until gelation begins, indicating the formation of a three-dimensional network structure through sol-gel polymerization of the titanium and carbon-containing precursors. In a preferred embodiment, the onset of gelation indicates that the hydrolysis and condensation reactions have progressed sufficiently to form a continuous gel network incorporating both the titanium oxide framework and the carbon-based glucose acetate components. The gelation process may take several hours depending on the specific concentrations and environmental conditions, with the mixture gradually increasing in viscosity as the sol-gel polymerization proceeds. In some preferred embodiments, the heating the mixture to form a gel establishes the three-dimensional porous structure that will be retained through subsequent drying and calcination steps to produce the final mesoporous composite material. As illustrated in FIG. 4, step 425 represents the transition from the liquid sol phase to the solid gel phase that characterizes the sol-gel synthesis approach for preparing mesoporous metal oxide materials. In another preferred embodiment, the water bath heating provides uniform temperature distribution throughout the reaction mixture during the gelation process.

During step 430, the resulting wet gel mass may be dried overnight at 70° C. (343 K) using either a vacuum oven or a convection oven to remove residual solvents and water from the gel structure. In a preferred embodiment, the drying the gel to form a dried gel removes volatile components including ethanol, water, and acetic acid from the gel matrix while preserving the three-dimensional porous network structure established during the gelation step 425. The drying process may be monitored to ensure complete removal of volatile components before proceeding to the subsequent heat treatment steps that consolidate the composite structure. In some preferred embodiments, the dried gel retains the porous morphology of the wet gel while exhibiting sufficient mechanical integrity for handling during the subsequent processing steps. As illustrated in FIG. 4, step 430 prepares the gel for the intermediate heating step 435 by removing residual solvents that would otherwise interfere with the thermal consolidation process. In another preferred embodiment, the vacuum oven drying may accelerate the removal of volatile components while preventing oxidation of the organic carbon components in the gel matrix.

During step 435, the dried gel may be heated in a furnace at 200° C. (473 K) at a temperature ramp rate of 2° C. per minute, maintained at this temperature for 4 hours, and then allowed to cool to room temperature. In a preferred embodiment, the intermediate heating step 435 facilitates initial consolidation of the composite structure and partial removal of organic components from the gel matrix while preserving the porous morphology established during the gelation and drying steps. The controlled heating rate of 2° C. per minute prevents thermal shock and cracking of the developing porous structure by allowing gradual temperature equilibration throughout the composite material. In some preferred embodiments, the 4-hour hold time at 200° C. (473 K) ensures sufficient thermal treatment for partial decomposition of the glucose acetate components and initial formation of the titanium oxide framework. As illustrated in FIG. 4, step 435 prepares the composite material for the subsequent oxidation treatment in step 440 by partially consolidating the structure and removing volatile organic decomposition products. In another preferred embodiment, the furnace heating provides uniform temperature distribution throughout the composite material during the thermal consolidation process.

During step 440, the obtained particles may be oxidized with a 2% hydrogen peroxide (H₂O₂) solution for 2 to 4 hours under continuous slow stirring to remove residual carbon and activate surface sites on the composite material. In a preferred embodiment, the oxidation treatment with hydrogen peroxide removes residual organic carbon from the composite matrix while generating active hydroxyl groups on the titanium oxide surface that serve as adsorption sites for germanium ions. The oxidation process may be performed at room temperature to prevent excessive reaction rates that could damage the porous structure of the composite material. In some preferred embodiments, the continuous slow stirring ensures uniform contact between the hydrogen peroxide solution and the composite particles throughout the oxidation treatment period. As illustrated in FIG. 4, step 440 activates the surface sites of the composite material by removing residual carbon and generating hydroxyl functional groups on the titanium oxide surface. In another preferred embodiment, the 2 to 4 hour oxidation time may be adjusted based on the amount of residual carbon present in the composite material following the intermediate heating step 435.

During step 445, the particles may be separated from the hydrogen peroxide solution and washed at least two times with deionized water to remove any impurities or unreacted components present in the particle matrix. In a preferred embodiment, the washing step 445 removes residual hydrogen peroxide, dissolved organic decomposition products, and any soluble impurities from the composite particles to prepare the material for the subsequent drying and calcination steps. Additional washing cycles may be performed if residual impurities are detected in the wash water, ensuring that the composite material is free of contaminants that could interfere with the germanium adsorption performance. In some preferred embodiments, the deionized water washing removes ionic impurities that could otherwise remain in the porous structure of the composite material and affect the surface chemistry of the final product. As illustrated in FIG. 4, step 445 prepares the oxidized composite particles for the drying step 450 by removing residual solution and impurities from the particle surfaces and pore structure. In another preferred embodiment, the separation of particles from the wash solution may be performed by filtration or centrifugation depending on the particle size and density of the composite material.

During step 450, the washed solid particles may be dried overnight at 70° C. (343 K) to remove absorbed water prior to high-temperature calcination in the subsequent step 455. In a preferred embodiment, the drying step 450 removes residual moisture from the composite particles to prevent steam generation during the high-temperature calcination process that could damage the porous structure of the material. The overnight drying time ensures complete removal of absorbed water from both the external surfaces and the internal pore structure of the composite particles. In some preferred embodiments, the drying temperature of 70° C. (343 K) provides sufficient thermal energy for water evaporation while avoiding thermal decomposition of any remaining organic components in the composite matrix. As illustrated in FIG. 4, step 450 prepares the composite particles for the calcination step 455 by ensuring that the material is free of moisture that could interfere with the high-temperature thermal treatment. In another preferred embodiment, the dried composite particles may be stored in a desiccator prior to calcination to prevent moisture reabsorption from the ambient atmosphere.

During step 455, the dried samples may be calcined in a furnace at 600° C. (873 K) with a temperature ramp rate of 2° C. per minute, maintained at this temperature for 4 hours, and then cooled to room temperature to obtain the porous TG composite resin. In a preferred embodiment, the calcining the dried gel at a temperature of at least 500° C. removes remaining organic matter and develops the final mesoporous structure with active surface sites for germanium adsorption from acidic aqueous solutions. The controlled temperature ramp rate of 2° C. per minute prevents thermal shock and maintains structural integrity of the porous composite material during the high-temperature calcination process. In some preferred embodiments, the 4-hour hold time at 600° C. (873 K) ensures complete removal of organic components and development of the crystalline titanium oxide phase that provides the active surface sites for germanium adsorption. As illustrated in FIG. 4, step 455 produces the TG composite resin designated as TG-600, which exhibits a germanium uptake capacity of 160 μg Ge/g of resin from a binary mixture in 0.05 M HCl. In another preferred embodiment, the TG-450 composite resin prepared by calcination at 450° C. exhibits a germanium uptake capacity of 250 μg Ge/g of resin from a binary mixture in 0.05 M HCl, demonstrating that lower calcination temperatures may provide higher germanium uptake capacity.

The method 400 may optionally include further heating a portion of the TG resin at 900° C. (1173 K) at a heating rate of 10° C. per minute for 1 hour to produce the TG-900 variant with enhanced stability in acidic solutions. In a preferred embodiment, the TG-900 composite resin exhibits a germanium uptake capacity of 120 μg Ge/g of resin and releases only 0.102 mg/L titanium to the solution, indicating enhanced stability in acidic solutions compared to the TG-450 and TG-600 variants. The higher calcination temperature of 900° C. (1173 K) produces a more stable crystalline titanium oxide phase that resists dissolution in the 0.05 M HCl solution during the germanium adsorption process. In some preferred embodiments, the selection between TG-450, TG-600, and TG-900 variants may depend on the specific application requirements balancing germanium uptake capacity against matrix stability in acidic environments. As illustrated in FIG. 4, step 465 indicates the termination of the method 400 following completion of the calcination step 455 or the optional high-temperature treatment to produce the TG-900 variant. In another preferred embodiment, the method 400 produces a mesoporous titanium-based composite material that may be employed in Ge-68/Ga-68 generator systems where selective retention of germanium is desired while gallium is eluted for radiopharmaceutical applications.

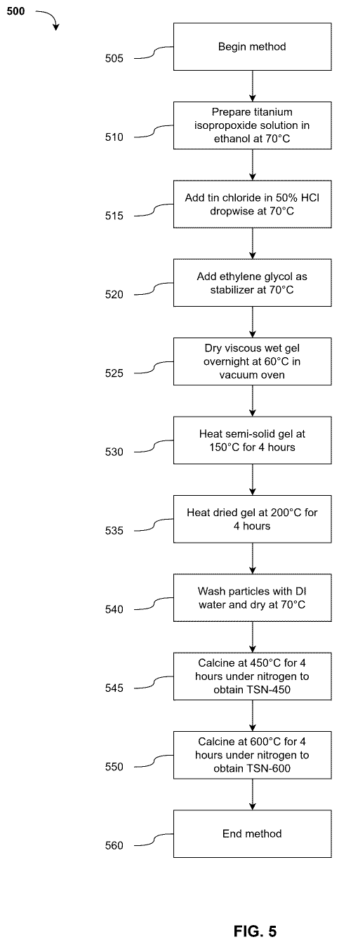

Referring to FIG. 5, a flowchart illustrates a method 500 of preparing a TSN (Titanium-Tin) activated composite resin for selective germanium removal from aqueous solutions using tin-doped titanium oxide prepared through sol-gel synthesis techniques. In a preferred embodiment, the method 500 begins at step 505, which indicates the beginning of the method 500 for preparing the mesoporous titanium-based composite material with a metal dopant dispersed within the titanium dioxide matrix. The method 500 proceeds through sequential processing steps that establish the titanium precursor, tin dopant, and thermal treatment conditions for producing the mesoporous composite structure with active surface sites for germanium adsorption. In some preferred embodiments, the method 500 employs ethylene glycol as a stabilizer that inhibits precipitation of metal ions and facilitates pore formation during subsequent heat treatment steps. As illustrated in FIG. 5, the method 500 includes steps for preparing precursor solutions, adding a metal dopant to the solution, multiple drying and heating stages, washing, and calcination to produce activated TSN composite variants with different adsorption characteristics. In another preferred embodiment, the method 500 produces a mesoporous titanium-based composite material that exhibits selective adsorption of germanium over gallium from acidic aqueous solutions containing 0.05 M hydrochloric acid.

During step 510, a titanium isopropoxide solution may be prepared by mixing a measured amount of titanium isopropoxide with 25 mL of ethanol under continuous stirring and constant heating at 70° C. (343 K). In a preferred embodiment, the titanium isopropoxide serves as the titanium precursor that undergoes hydrolysis and condensation reactions to form the titanium dioxide matrix of the mesoporous composite material. The mixture may be maintained under continuous stirring and heating conditions until the titanium alkoxide precursor is fully dissolved in the ethanol solvent, producing a clear and homogeneous solution. In some preferred embodiments, the molar ratio of tin in the composite may be varied from 1% to 5% to optimize germanium and gallium uptake characteristics from aqueous solutions, with the calcining temperature also varied from 450° C. (723 K) to 700° C. (973 K) to establish optimal adsorption performance. As illustrated in FIG. 5, step 510 prepares the titanium-containing solution that will be combined with the tin dopant solution in the subsequent step 515 to form the tin-doped titanium composite precursor mixture. In another preferred embodiment, the titanium isopropoxide-ethanol solution serves as the primary matrix component for the tin-doped composite material that will be formed through subsequent gelation and calcination steps.

During step 515, tin chloride in 50% HCl solution (10 mL) may be added dropwise to the titanium isopropoxide-ethanol mixture under continuous stirring at 70° C. (343 K). In a preferred embodiment, the metal dopant comprises tin derived from stannous chloride, which is incorporated into the titanium dioxide matrix through the sol-gel polymerization process to enhance germanium adsorption selectivity. The dropwise addition ensures controlled incorporation of the tin dopant into the developing titanium oxide network structure while preventing rapid precipitation that could result in non-uniform dopant distribution. In some preferred embodiments, the final molar ratio of titanium to tin may be maintained at approximately 0.95:0.05 to achieve optimal germanium adsorption characteristics while maintaining structural stability of the composite material. As illustrated in FIG. 5, step 515 introduces the tin dopant that will be dispersed within the titanium dioxide matrix to modify the surface chemistry and enhance selective germanium adsorption over gallium. In another preferred embodiment, the acidic HCl solution containing the tin chloride also promotes hydrolysis of the titanium isopropoxide precursor, facilitating the sol-gel polymerization reactions that form the composite network structure.

During step 520, at least 1.0 mL of ethylene glycol may be added to the mixture as a stabilizer under continuous stirring and constant heating at 70° C. (343 K) using a water bath. In a preferred embodiment, the ethylene glycol inhibits precipitation of the metal ions and stabilizes the reaction process during polymerization by forming coordination complexes with the titanium and tin species in solution. The ethylene glycol may facilitate surface morphological changes by promoting pore formation upon subsequent heat treatment, resulting in a more porous composite structure compared to materials prepared without the stabilizer. In some preferred embodiments, under continuous stirring and heating, a complex reaction product may be formed through the polymerization reaction between the titanium, tin, ethanol, and ethylene glycol components, with the mixture gradually transforming into a viscous wet gel as the polymerization proceeds. As illustrated in FIG. 5, step 520 adds the stabilizer component that contributes to the mesoporous structure of the final composite material by controlling the precipitation and aggregation behavior of the metal oxide precursors. In another preferred embodiment, the viscosity of the mixture may be monitored to determine the optimal point for proceeding to the drying stages when the gelation process has progressed sufficiently.

During step 525, the viscous wet gel may be dried overnight at 60° C. (333 K) in a vacuum oven to produce a semi-solid wax-like gel. In a preferred embodiment, the vacuum environment accelerates the removal of volatile components including ethanol and water while preventing oxidation of the tin species during the initial drying stage. The overnight drying time ensures sufficient removal of residual solvents from the gel matrix while preserving the three-dimensional porous network structure established during the gelation process. In some preferred embodiments, the semi-solid wax-like gel retains the tin dopant uniformly distributed throughout the titanium oxide matrix, which will be further consolidated through subsequent heat treatment steps. As illustrated in FIG. 5, step 525 prepares the gel for the intermediate heating step 530 by removing residual solvents that would otherwise interfere with the thermal consolidation process. In another preferred embodiment, the vacuum oven drying at 60° C. (333 K) provides gentle thermal treatment that removes volatile components without causing thermal decomposition of the organic stabilizer components in the gel matrix.

During step 530, the semi-solid gel may be further heated for four hours at 150° C. (423 K) in a vacuum oven and then cooled to room temperature. In a preferred embodiment, the intermediate heating step 530 facilitates partial consolidation of the composite structure while beginning the removal of organic components from the gel matrix. The four-hour hold time at 150° C. (423 K) ensures sufficient thermal treatment for partial decomposition of the ethylene glycol stabilizer and initial formation of the tin-doped titanium oxide framework. In some preferred embodiments, the controlled heating rate may prevent thermal stress and maintain structural integrity of the developing tin-doped composite particles during the intermediate consolidation process. As illustrated in FIG. 5, step 530 prepares the composite material for the subsequent heating step 535 by partially consolidating the structure and initiating the formation of tin titanate phases. In another preferred embodiment, the vacuum environment during the heating step 530 prevents oxidation of the tin species while allowing removal of volatile organic decomposition products from the gel matrix.

During step 535, the dried gel may be heated for an additional four hours at 200° C. (473 K) in a vacuum oven to continue the thermal consolidation process. In a preferred embodiment, when using a muffle furnace, the temperature may be increased at a rate of 2° C. per minute to reach 200° C. (473 K), maintained for 4 hours, and then allowed to cool to room temperature. The heating process at 200° C. (473 K) facilitates the formation of solid composite particulate materials and the development of tin titanate phases with the release of combustion products including carbon dioxide. In some preferred embodiments, the controlled heating rate prevents thermal stress and maintains structural integrity of the developing composite particles while allowing gradual removal of organic components. As illustrated in FIG. 5, step 535 produces solid TSN particles through thermal consolidation of the gel matrix with the tin dopant incorporated into the titanium oxide framework. In another preferred embodiment, the formation of tin titanate phases occurs at this stage as the organic stabilizer components are removed and the metal oxide network structure becomes more crystalline.

During step 540, the composite particulate material may be washed twice with deionized water to remove any impurities or unreacted components present in the particles, and the washed particles may then be dried overnight at 70° C. (343 K) to obtain solid composite particles. In a preferred embodiment, the washing step 540 removes residual organic decomposition products, dissolved ionic species, and any soluble impurities from the TSN particles to prepare the material for the subsequent calcination steps. The drying and calcination temperature may affect the crystalline phase of the material, which in turn influences the adsorption performance characteristics of the final composite product. In some preferred embodiments, the overnight drying at 70° C. (343 K) ensures complete removal of absorbed water from both the external surfaces and the internal pore structure of the composite particles prior to high-temperature calcination. As illustrated in FIG. 5, step 540 prepares the TSN particles for the calcination step 545 by ensuring that the material is free of impurities and moisture that could interfere with the high-temperature thermal treatment. In another preferred embodiment, the deionized water washing removes ionic impurities that could otherwise remain in the porous structure of the composite material and affect the surface chemistry of the final product.

During step 545, the dried TSN samples may be calcined in a furnace at 450° C. (723 K) at a rate of 3° C. per minute temperature increase, maintained at this temperature for 4 hours under nitrogen environment, and then cooled to room temperature to obtain the mesoporous TSN-450 composite. In a preferred embodiment, the nitrogen environment prevents oxidation of the tin species during the calcination process while allowing development of the mesoporous structure with active surface sites for germanium adsorption. The TSN-450 composite resin exhibits a germanium uptake capacity of 2.13 mg Ge/g and releases 14.61 mg/L Ti and 3.32 mg/L Sn to the solution during adsorption experiments with binary mixtures of germanium and gallium in 0.05 M HCl. In some preferred embodiments, the TSN-450 composite may serve as an intermediate product for further high-temperature treatment to produce activated variants with different adsorption characteristics and enhanced stability in acidic environments. As illustrated in FIG. 5, step 545 produces the TSN-450 composite through calcination at a temperature below the 500° C. to 600° C. range used for the more stable TSN-600 variant. In another preferred embodiment, the composite material is calcined at a temperature ranging from 500° C. to 600° C. in subsequent processing steps to achieve enhanced stability while maintaining germanium adsorption capacity.

During step 550, the TSN-450 particles may be further calcined in a furnace at 600° C. (873 K) at a rate of 3° C. per minute temperature increase, maintained for 4 hours under nitrogen environment, and then cooled to room temperature to produce the activated TSN-600 composite. In a preferred embodiment, the multiple stages of heating, washing, drying, and cooling remove unreacted components as impurities from the matrix and produce an activated tin-doped titanium composite with enhanced germanium selectivity and reduced metal ion dissolution in acidic solutions. The TSN-600 composite resin exhibits a germanium uptake capacity of 1.59 mg Ge/g and releases 4.8 mg/L Ti and 0.45 mg/L Sn to the solution, demonstrating enhanced stability compared to the TSN-450 variant. In some preferred embodiments, the doping of titania with tin creates a charge compensating anion vacancy and causes a transformation to the stable rutile phase, which contributes to the enhanced stability of the TSN-600 composite in 0.05 M HCl solution. As illustrated in FIG. 5, step 550 produces the activated TSN-600 composite through calcination at 600° C. (873 K), which falls within the temperature range of 500° C. to 600° C. specified for producing stable mesoporous titanium-based composite materials. In another preferred embodiment, the TSN-600 composite may be selected for further modification with organic functional groups to enhance germanium uptake capacity while maintaining stability in acidic solutions.

The method 500 may optionally include further heating a portion of the TSN-450 resin at 700° C. (973 K) at a rate of 10° C. per minute for 1 hour under argon environment to produce the activated TSN-700 composite. In a preferred embodiment, the TSN-700 composite resin exhibits a germanium uptake capacity of 0.7 mg Ge/g and releases 2.2 mg/L Ti and 0.4 mg/L Sn to the solution, indicating enhanced stability in acidic solutions compared to the TSN-450 and TSN-600 variants. The argon environment prevents oxidation of the tin species during the high-temperature treatment while allowing development of a more stable crystalline structure that resists dissolution in the 0.05 M HCl solution. In some preferred embodiments, the selection between TSN-450, TSN-600, and TSN-700 variants may depend on the specific application requirements balancing germanium uptake capacity against matrix stability in acidic environments. As illustrated in FIG. 5, step 560 indicates the termination of the method 500 following completion of the calcination step 550 or the optional high-temperature treatment to produce the TSN-700 variant. In another preferred embodiment, the method 500 produces a mesoporous titanium-based composite material with a titanium dioxide matrix and a metal dopant comprising tin dispersed within the titanium dioxide matrix that may be employed in Ge-68/Ga-68 generator systems where selective retention of germanium is desired while gallium is eluted for radiopharmaceutical applications.

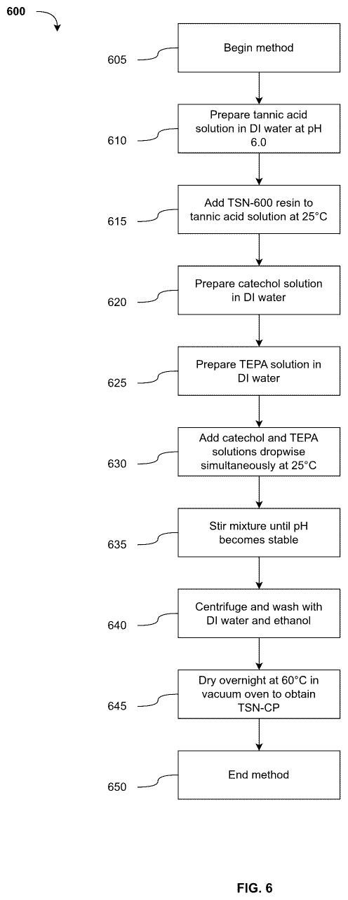

Referring to FIG. 6, a flowchart illustrates a method 600 of preparing a TSN-CP crosslinked composite resin for enhanced germanium removal from aqueous solutions through modification of the activated TSN-600 composite with organic functional groups. In a preferred embodiment, the method 600 begins at step 605, which indicates the beginning of the method 600 for preparing the crosslinked mesoporous titanium-based composite material with organic functional groups attached to the titanium dioxide matrix. The method 600 proceeds through sequential processing steps that establish the crosslinking medium, introduce the activated TSN-600 resin, and combine the catechol and TEPA crosslinking agents to form the functionalized composite surface. In some preferred embodiments, the method 600 employs tannic acid as a crosslinking agent that facilitates functional polymeric networks through hydrogen bonding interactions between the polyphenol moieties and the composite surface. As illustrated in FIG. 6, the method 600 includes steps for preparing separate solutions, simultaneous dropwise addition of crosslinking agents, pH stabilization, washing, and drying to produce the TSN-CP composite with enhanced germanium uptake capacity. In another preferred embodiment, the method 600 produces a mesoporous titanium-based composite material from a 0.05 M hydrochloric acid solution while maintaining stability in acidic environments.

During step 610, a tannic acid solution may be prepared by dissolving a measured quantity of tannic acid in deionized (DI) water to achieve a solution pH of approximately 6.0. In a preferred embodiment, tannic acid is a natural polyphenol compound containing a high concentration of dihydroxyphenyl (catechol) and trihydroxyphenyl (pyrogallol) moieties that serve as a crosslinking agent for functional polymeric networks on the composite surface. The catechol groups present in the tannic acid have the capability to react as anchoring groups for a wide range of substrates through hydrogen bonding interactions that facilitate adhesion of the polyphenol toward the TSN-600 composite surface. In some preferred embodiments, the tannic acid solution may be prepared at room temperature with gentle mixing to ensure complete dissolution prior to the addition of the TSN-600 resin in the subsequent step 615. As illustrated in FIG. 6, step 610 establishes the crosslinking medium that will facilitate the attachment of organic functional groups to the activated TSN-600 matrix through the subsequent crosslinking reactions. In another preferred embodiment, the pH of the tannic acid solution may be monitored and adjusted as needed before proceeding to subsequent steps to ensure optimal conditions for the crosslinking reaction.

During step 615, approximately 1 g of activated TSN-600 resin may be added to the tannic acid solution under continuous stirring at 25° C. (298 K). In a preferred embodiment, the continuous stirring disperses the TSN-600 resin particles to eliminate agglomeration and ensure even surface coating with the tannic acid solution throughout the particle population. The stirring rate may be adjusted to promote uniform dispersion while preventing mechanical damage to the resin particles during the mixing process. In some preferred embodiments, the TSN-600 resin particles become coated with the tannic acid solution, which provides anchoring sites for the subsequent attachment of catechol and TEPA crosslinking agents. As illustrated in FIG. 6, step 615 introduces the activated TSN-600 resin into the crosslinking medium where the tannic acid facilitates surface modification through hydrogen bonding interactions. In another preferred embodiment, the titanium dioxide matrix of the TSN-600 resin may comprise a rutile phase that provides a stable crystalline structure for attachment of the organic functional groups during the crosslinking process.

During step 620, a catechol solution may be prepared separately by dissolving a measured amount of catechol (1,2-dihydroxybenzene) in deionized water. In a preferred embodiment, catechol contains oxygen-containing organic ligands that may form complexes with germanium ions, thereby enhancing the germanium uptake capacity of the final composite material compared to the unmodified TSN-600 resin. The catechol solution may be prepared at room temperature and set aside for subsequent addition to the reaction mixture containing the dispersed TSN-600 resin in the tannic acid solution. In some preferred embodiments, the catechol serves as a precursor that undergoes oxidation to form reactive quinone groups in the presence of the tin species (Sn²⁺/Sn⁴⁺) present in the activated TSN-600 matrix. As illustrated in FIG. 6, step 620 prepares the catechol crosslinking agent that will be combined with the TEPA solution in the subsequent simultaneous addition step 630. In another preferred embodiment, the organic functional group attached to the titanium dioxide matrix comprises a catechol-containing compound that participates in the crosslinking reactions to form the TSN-CP composite.

During step 625, a tetraethylpentamine (TEPA) solution may be prepared separately by dissolving a measured amount of TEPA in deionized water. In a preferred embodiment, the TEPA serves as a source of amine groups that participate in the crosslinking reaction through Michael addition and Schiff base reactions with the oxidized catechol species generated in the presence of the tin dopant. The TEPA molecule contains five nitrogen atoms connected by ethylene bridges, with terminal primary amine groups and secondary amine groups along the chain that provide multiple reactive sites for crosslinking with the quinone intermediate. In some preferred embodiments, the TEPA solution may be prepared at room temperature and set aside for subsequent simultaneous addition with the catechol solution to the reaction mixture. As illustrated in FIG. 6, step 625 prepares the TEPA crosslinking agent that will be combined with the catechol solution in the subsequent simultaneous addition step 630 to form the crosslinked polymer network on the TSN-600 surface. In another preferred embodiment, the amine groups of TEPA function as nucleophiles that attack the electrophilic carbonyl carbons of the quinone formed from catechol oxidation, creating covalent bonds that stabilize the crosslinked network structure.

During step 630, both the catechol solution and the TEPA solution may be added dropwise and simultaneously to the tannic acid solution containing the dispersed TSN-600 resin under continuous stirring at 25° C. (298 K). In a preferred embodiment, the dropwise addition may be performed gradually to avoid agglomeration of the reaction components and to promote uniform distribution of the crosslinking agents throughout the resin matrix. The presence of tin species (Sn²⁺/Sn⁴⁺) in the activated TSN-600 matrix promotes oxidation of catechol to form reactive quinone groups, which favors the crosslinking reaction mechanism with the amine groups of TEPA. In some preferred embodiments, a strong cation-π interaction may take place among the oxidation product of catechol, the amine groups of TEPA, and the TSN-600 matrix through Michael addition reaction and Schiff base reaction. As illustrated in FIG. 6, step 630 initiates the crosslinking reaction by combining the catechol and TEPA solutions with the TSN-600 resin dispersed in the tannic acid medium. In another preferred embodiment, the simultaneous dropwise addition ensures that the catechol and TEPA react together on the TSN-600 surface rather than reacting separately, which promotes formation of the desired crosslinked catechol-TEPA network structure.

During step 635, the mixture may be maintained under continuous stirring for at least two hours until the solution pH becomes stable, indicating completion of the crosslinking reaction. In a preferred embodiment, the molar amounts of tannic acid, catechol, TEPA, and DI water in the mixture may be 1.2×10⁻⁵, 3.1×10⁻³, 6.34×10⁻⁴, and 5.6 mole, respectively, as these ratios were established through optimization to achieve desired crosslinking characteristics and germanium uptake performance. The pH stabilization indicates that the crosslinking reactions between the catechol-derived quinone species and the TEPA amine groups have reached completion, with the reactive intermediates consumed in forming the crosslinked polymer network. In some preferred embodiments, the continuous stirring throughout the two-hour reaction period ensures uniform contact between the crosslinking agents and the TSN-600 resin particles, promoting consistent surface modification across the particle population. As illustrated in FIG. 6, step 635 allows the crosslinking reaction to proceed to completion as indicated by the stabilization of the solution pH. In another preferred embodiment, the mesoporous titanium-based composite material may further comprise a surfactant template derived from a triblock copolymer when the TSN-600 precursor is prepared using such templates, although the crosslinking process described in the method 600 does not require additional surfactant addition.

During step 640, the crosslinked resin may be obtained by centrifugation and washed repeatedly with deionized water and ethanol to remove any impurities or unreacted components that may be present in the composite matrix. In a preferred embodiment, the washing process may be repeated until the wash solution becomes clear, indicating removal of excess reagents including unreacted catechol, TEPA, and tannic acid from the crosslinked composite particles. The ethanol washing removes organic impurities that may not be soluble in water, ensuring thorough cleaning of the crosslinked TSN-CP composite surface. In some preferred embodiments, the centrifugation separates the crosslinked resin particles from the wash solution, allowing efficient removal of the supernatant containing dissolved impurities and unreacted components. As illustrated in FIG. 6, step 640 purifies the crosslinked TSN-CP composite by removing residual reagents and reaction byproducts from the particle surfaces and pore structure. In another preferred embodiment, the repeated washing with both deionized water and ethanol ensures that the crosslinked composite is free of contaminants that could interfere with the germanium adsorption performance or cause unwanted metal ion release during use.

During step 645, the washed crosslinked resin may be dried overnight using a vacuum oven at 60° C. (333 K) to obtain solid activated TSN-CP composite particles. In a preferred embodiment, the vacuum environment accelerates the removal of residual solvents including water and ethanol while preventing oxidation of the organic functional groups on the composite surface during the drying process. The overnight drying time ensures complete removal of absorbed solvents from both the external surfaces and the internal pore structure of the crosslinked composite particles. In some preferred embodiments, the resulting TSN-CP composite exhibits anionic functional groups on its surface sites due to the crosslinked catechol-TEPA network, which facilitates selective adsorption of cationic germanium species through Coulombic interactions. As illustrated in FIG. 6, step 650 indicates the termination of the method 600 following completion of the drying step 645 to produce the activated TSN-CP composite particles. In another preferred embodiment, the TSN-CP composite resin exhibits a germanium uptake capacity of 5.71 mg Ge/g and releases only 1.01 mg/L Ti and 0.15 mg/L Sn to the solution, demonstrating enhanced germanium uptake capacity and improved stability compared to the unmodified TSN-600 composite.

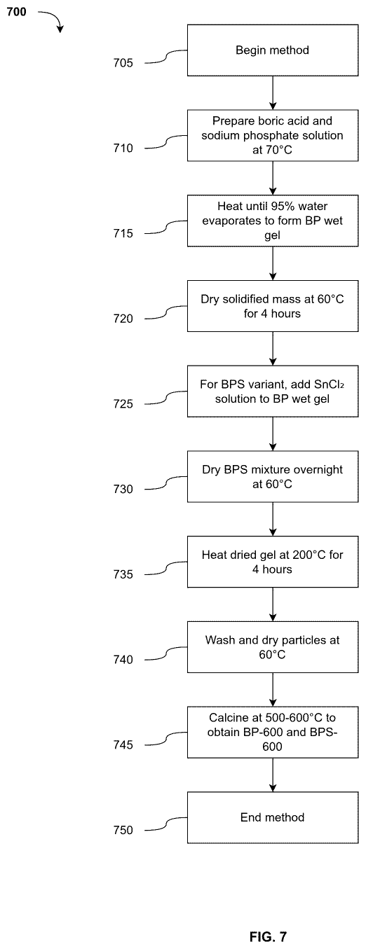

Referring to FIG. 7, a flowchart illustrates a method 700 of preparing BP and BPS mesoporous composite resins for selective germanium removal from aqueous solutions using boron-phosphate based materials prepared through sol-gel synthesis techniques. In a preferred embodiment, the method 700 begins at step 705, which indicates the beginning of the method 700 for preparing the mesoporous boron-based composite material with a boron-containing matrix derived from boric acid and a phosphorus-containing component derived from sodium monobasic phosphate. The method 700 proceeds through sequential processing steps that establish the boron and phosphorus precursors, evaporation conditions, and thermal treatment parameters for producing the mesoporous composite structure with active surface sites for germanium adsorption. In some preferred embodiments, the method 700 employs boric acid as a source of boron and sodium monobasic phosphate (NaH₂PO₄) as a source of phosphorus, which combine through polymerization reactions to form the boron-phosphate matrix structure. As illustrated in FIG. 7, the method 700 includes steps for preparing precursor solutions, evaporation to form gel, drying, optional tin doping for the BPS variant, heat treatment, washing, and calcination to produce activated BP and BPS composite resins with different adsorption characteristics. In another preferred embodiment, the method 700 produces mesoporous boron-phosphate composite materials that may be used to remove germanium and gallium from mixed processing waste solutions containing higher amounts of germanium.

During step 710, a boric acid and sodium monobasic phosphate solution may be prepared by dissolving boric acid in deionized (DI) water and adding a measured amount of sodium monobasic phosphate (NaH₂PO₄) under continuous stirring and constant heating at 70° C. (343 K). In a preferred embodiment, the boric acid serves as the boron source for the mesoporous boron-based composite material, while the sodium monobasic phosphate provides the phosphorus component that combines with the boron to form the boron-phosphate matrix structure. Finally, the amount of boric acid, sodium monobasic phosphate, and deionized water was 8.08×10-3, 0.0243, and 1.1 mole, respectively, in the mixture. In some preferred embodiments, the polymerization reaction among the components may proceed according to the reaction: NaH₂PO₄+H₃BO₄→B(H₂PO₄)₃+3NaOH, which forms the boron-phosphate network structure with sodium hydroxide as a byproduct. As illustrated in FIG. 7, step 710 establishes the boron and phosphorus precursor solution that will be concentrated through evaporation in the subsequent step 715 to form the gel phase. In another preferred embodiment, the continuous stirring and heating at 70° C. (343 K) ensures complete dissolution of both the boric acid and sodium monobasic phosphate components while initiating the polymerization reactions that form the boron-phosphate network.

During step 715, the solution may be heated at 70° C. (343 K) under continuous stirring using a water bath until approximately 95% of the water evaporates and the remaining 5% concentrated solution becomes a wet gel. In a preferred embodiment, the evaporation process concentrates the boron and phosphorus species in the solution, promoting polymerization reactions that form the three-dimensional boron-phosphate network structure characteristic of the gel phase. The wet gel formed through the evaporation process is designated as boron-phosphate (BP) gel, which serves as the precursor material for the subsequent drying and calcination steps. In some preferred embodiments, the continuous stirring during the evaporation process ensures uniform concentration of the boron and phosphorus species throughout the gel matrix, preventing localized precipitation that could result in non-uniform composition. As illustrated in FIG. 7, step 715 transforms the liquid precursor solution into the gel phase through controlled evaporation while maintaining the temperature at 70° C. (343 K). In another preferred embodiment, the 95% water evaporation endpoint may be determined by monitoring the volume or mass of the solution during the heating process, with the onset of gelation indicating that sufficient concentration has been achieved.

During step 720, the wet gel may be maintained under stirring and heating at 70° C. (343 K) until the mass solidifies, and the solidified mass may then be dried in a vacuum oven at 60° C. (333 K) for four hours to produce the dried BP-gel. In a preferred embodiment, the continued heating and stirring after gelation promotes further polymerization of the boron-phosphate network while removing residual water from the gel matrix. The vacuum oven drying at 60° C. (333 K) removes remaining moisture from the gel structure while preserving the three-dimensional porous network established during the gelation and solidification process. In some preferred embodiments, the four-hour drying time ensures sufficient removal of residual water from the gel matrix while avoiding thermal decomposition of the boron-phosphate network structure. As illustrated in FIG. 7, step 720 prepares the dried BP-gel for subsequent processing, which may include either direct heat treatment for the BP variant or tin doping for the BPS variant. In another preferred embodiment, the dried BP-gel retains the porous morphology of the wet gel while exhibiting sufficient mechanical integrity for handling during the subsequent processing steps.

During step 725, for the BPS variant, a stannous chloride (SnCl₂) solution may be prepared and added to the BP wet gel under continuous stirring and heating at 70° C. (343 K) to incorporate tin as a metal dopant into the boron-phosphate matrix. In a preferred embodiment, the molar ratio of B, P, and Sn was 8.08×10-3:0.0243:0.0243, respectively, in the mixture. The stannous chloride solution may be prepared using deionized water and added to the BP wet gel before the gel has completely solidified, allowing the tin species to be uniformly distributed throughout the boron-phosphate matrix. In some preferred embodiments, the continuous stirring and heating at 70° C. (343 K) ensures uniform incorporation of the tin dopant into the developing boron-phosphate network structure. As illustrated in FIG. 7, step 725 introduces the tin dopant that will be dispersed within the boron-phosphate matrix to modify the surface chemistry and adsorption characteristics of the BPS composite material. In another preferred embodiment, the tin doping process for the BPS variant follows the BP gel preparation process with the addition of the stannous chloride component prior to the final solidification and drying steps.

During step 730, the BPS mixture may be dried overnight at 60° C. (333 K) in a vacuum oven to produce a semi-solid wax-like gel designated as BPS gel. In a preferred embodiment, the overnight drying time ensures sufficient removal of residual water and volatile components from the tin-doped boron-phosphate gel matrix while preserving the three-dimensional porous network structure. The vacuum environment accelerates the removal of volatile components while preventing oxidation of the tin species during the drying process. In some preferred embodiments, the semi-solid wax-like BPS gel retains the tin dopant uniformly distributed throughout the boron-phosphate matrix, which will be further consolidated through subsequent heat treatment steps. As illustrated in FIG. 7, step 730 prepares the BPS gel for the intermediate heating step 735 by removing residual solvents that would otherwise interfere with the thermal consolidation process. In another preferred embodiment, the vacuum oven drying at 60° C. (333 K) provides gentle thermal treatment that removes volatile components without causing thermal decomposition of the boron-phosphate network or oxidation of the tin dopant species.

During step 735, the dried gel for both BP and BPS variants may be heated at 200° C. (473 K) for four hours to facilitate the formation of solid composite particulate materials. In a preferred embodiment, when using a furnace, the temperature may be increased at a rate of 4° C. per minute to reach 200° C. (473 K), maintained for four hours, and then allowed to cool to room temperature. The heating process at 200° C. (473 K) facilitates thermal consolidation of the boron-phosphate network structure while removing residual organic components and water from the gel matrix. In some preferred embodiments, the controlled heating rate of 4° C. per minute prevents thermal shock and maintains structural integrity of the developing composite particles while allowing gradual removal of volatile components. As illustrated in FIG. 7, step 735 produces solid BP and BPS particles through thermal consolidation of the gel matrix with the boron-phosphate network structure becoming more stable. In another preferred embodiment, the four-hour hold time at 200° C. (473 K) ensures sufficient thermal treatment for consolidation of the composite structure and initial development of the mesoporous morphology.

During step 740, the composite particulate material may be washed with deionized water and dried at 60° C. (333 K) to obtain solid composite particles free of impurities and unreacted components. In a preferred embodiment, the washing step 740 removes residual sodium hydroxide byproduct, dissolved ionic species, and any soluble impurities from the BP and BPS particles to prepare the material for the subsequent calcination step. The deionized water washing removes ionic impurities that could otherwise remain in the porous structure of the composite material and affect the surface chemistry of the final product. In some preferred embodiments, the drying at 60° C. (333 K) ensures complete removal of absorbed water from both the external surfaces and the internal pore structure of the composite particles prior to high-temperature calcination. As illustrated in FIG. 7, step 740 prepares the BP and BPS particles for the calcination step 745 by ensuring that the material is free of impurities and moisture that could interfere with the high-temperature thermal treatment. In another preferred embodiment, the washing and drying process may be repeated if residual impurities are detected in the wash water, ensuring thorough purification of the composite particles.

During step 745, both BP and BPS samples may be calcined at temperatures ranging from 500° C. (773 K) to 600° C. (873 K) at a rate of 4° C. per minute for four hours to obtain the final BP-600 and BPS-600 composite resins with mesoporous structures and active surface sites for germanium adsorption. In a preferred embodiment, the calcination at 600° C. (873 K) develops the final mesoporous structure with active surface sites while removing any remaining organic components from the composite matrix. The controlled temperature ramp rate of 4° C. per minute prevents thermal shock and maintains structural integrity of the porous composite material during the high-temperature calcination process. In some preferred embodiments, the mesoporous boron-phosphate composite material (BP-600) exhibits a germanium uptake capacity of 1.804 mg Ge/g and a gallium uptake capacity of 0.713 mg Ga/g from a binary mixture in 0.05 M HCl. As illustrated in FIG. 7, step 750 indicates the termination of the method 700 following completion of the calcination step 745 to produce the activated BP-600 and BPS-600 composite particles. In another preferred embodiment, the tin-doped boron-phosphate composite material (BPS-600) exhibits a germanium uptake capacity of 1.20 mg Ge/g and a gallium uptake capacity of 2.77 mg Ga/g from a binary mixture in 0.05 M HCl, demonstrating that the tin doping modifies the adsorption selectivity characteristics of the boron-phosphate matrix.

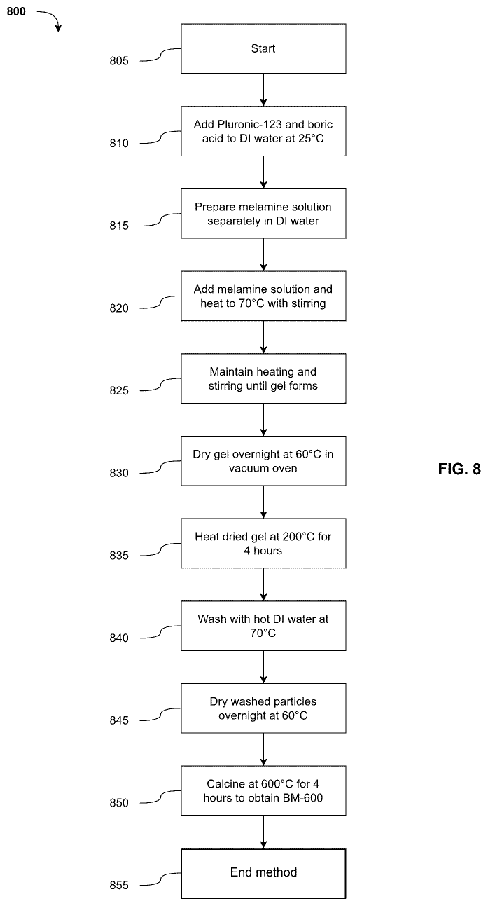

Referring to FIG. 8, a flowchart illustrates a method 800 of preparing a BM (Boron-Melamine) mesoporous composite resin for selective germanium removal from aqueous solutions using boron-melamine based materials prepared through sol-gel synthesis techniques with surfactant templating. In a preferred embodiment, the method 800 begins at step 805, which indicates the beginning of the method 800 for preparing the mesoporous boron-based composite material with a boron-containing matrix derived from boric acid and a nitrogen-containing component derived from melamine incorporated into the boron-containing matrix. The method 800 proceeds through sequential processing steps that establish the surfactant template, boron precursor, melamine component, and thermal treatment parameters for producing the mesoporous composite structure with active surface sites for germanium adsorption. In some preferred embodiments, the method 800 employs dissolving a surfactant in deionized water to form a surfactant solution, where the surfactant comprises a triblock copolymer Pluronic-123 (E0₂₀P0₇₀E0₂₀) that serves as a template for developing the mesoporous structure during the sol-gel synthesis process. As illustrated in FIG. 8, the method 800 includes steps for adding boric acid to the surfactant solution under stirring, preparing a melamine solution separately, combining the melamine solution with the boric acid-surfactant solution and heating the combined mixture to form a gel, drying the gel to form a dried gel, and calcining the dried gel at a temperature of at least 500° C. to obtain the mesoporous boron-based composite material. In another preferred embodiment, the method 800 produces a mesoporous boron-melamine composite material that exhibits selective adsorption characteristics for germanium from acidic aqueous solutions containing 0.05 M hydrochloric acid.

During step 810, Pluronic-123 surfactant and boric acid may be added to deionized water under continuous stirring at room temperature 25° C. to form the surfactant-boric acid solution that serves as the foundation for the boron-melamine composite matrix. In a preferred embodiment, step 810 corresponds to adding Pluronic-123 and boric acid to DI water at 25° C., where the triblock copolymer surfactant is first dissolved in the deionized water before the boric acid is added under continuous stirring to ensure uniform distribution of both components. The boric acid serves as the boron source for the mesoporous boron-based composite material, while the Pluronic-123 surfactant provides the template structure that will develop into the mesoporous morphology during subsequent thermal treatment steps. In a preferred embodiment, the molar ratio of P-123, boric acid, melamine, and acetic acid was 6.89×10-5:0.015:7.53×10-3:0.12, respectively, in the solution. As illustrated in FIG. 8, step 810 establishes the surfactant-boric acid solution that will be combined with the melamine solution in the subsequent step 820 to form the composite precursor mixture. In another preferred embodiment, the continuous stirring at room temperature ensures complete dissolution of both the Pluronic-123 surfactant and the boric acid components while preventing premature gelation of the mixture.

During step 815, a melamine solution may be prepared separately by dissolving melamine (C₃H₆N₆) in deionized water with or without the addition of acetic acid to facilitate dissolution of the melamine component. In a preferred embodiment, the melamine serves as the nitrogen-containing component that will be incorporated into the boron-containing matrix to provide nitrogen donor atoms that may participate in germanium adsorption through coordination interactions. The melamine solution may be prepared using approximately 15 mL of 50% glacial acetic acid to prepare a melamine-acetic acid solution mixture when acetic acid is employed to enhance the solubility of the melamine in the aqueous medium. In some preferred embodiments, the melamine solution may be prepared at room temperature with gentle mixing to ensure complete dissolution of the melamine prior to combining with the boric acid-surfactant solution in the subsequent step 820. As illustrated in FIG. 8, step 815 prepares the melamine component separately from the boric acid-surfactant solution, which allows for controlled addition and mixing of the two precursor solutions. In another preferred embodiment, the separate preparation of the melamine solution ensures that the melamine is fully dissolved before being combined with the boric acid-surfactant solution, preventing localized precipitation that could result in non-uniform composition of the final composite material.

During step 820, the melamine solution may be added to the boric acid-Pluronic-123 solution and the combined mixture may be heated to 70° C. (343 K) using a water bath under vigorous stirring for approximately one hour to obtain a clear solution. In a preferred embodiment, step 820 corresponds to adding melamine solution and heating to 70° C. with stirring, where the combining the melamine solution with the boric acid-surfactant solution and heating the combined mixture initiates the sol-gel polymerization reactions that form the boron-melamine network structure. The vigorous stirring ensures uniform mixing of the melamine with the boric acid and surfactant components, promoting homogeneous distribution of the nitrogen-containing melamine throughout the developing boron-based matrix. In some preferred embodiments, the heating to 70° C. (343 K) accelerates the polymerization reactions between the boric acid and melamine components while the Pluronic-123 surfactant organizes into micellar structures that template the mesoporous morphology. As illustrated in FIG. 8, step 820 combines the separately prepared solutions and initiates the thermal treatment that will lead to gel formation in the subsequent step 825. In another preferred embodiment, the one-hour heating period at 70° C. (343 K) provides sufficient time for the polymerization reactions to proceed while the solution remains clear, indicating that the sol phase has not yet transitioned to the gel phase.

During step 825, the combined mixture may be maintained under continuous heating and stirring until a semi-solid gel forms, with the gelation process occurring in less than one hour under the specified conditions. In a preferred embodiment, the onset of gelation indicates that the polymerization reactions between the boric acid and melamine components have progressed sufficiently to form a continuous three-dimensional network structure incorporating both the boron-containing matrix and the nitrogen-containing melamine component. The heating the combined mixture to form a gel establishes the porous structure that will be retained through subsequent drying and calcination steps to produce the final mesoporous boron-melamine composite material. In some preferred embodiments, the continuous stirring during the gelation process ensures uniform distribution of the surfactant template throughout the gel matrix, which will develop into the mesoporous morphology during the thermal treatment steps. As illustrated in FIG. 8, step 825 represents the transition from the liquid sol phase to the semi-solid gel phase that characterizes the sol-gel synthesis approach for preparing mesoporous boron-melamine materials. In another preferred embodiment, the gelation time of less than one hour indicates that the polymerization reactions proceed rapidly under the specified temperature and composition conditions, allowing efficient production of the gel precursor material.

During step 830, the semi-solid gel may be dried overnight at 60° C. (333 K) in a vacuum oven to produce a solid wax-like gel designated as boron-melamine (BM) gel. In a preferred embodiment, step 830 corresponds to drying gel overnight at 60° C. in vacuum oven, where the drying the gel to form a dried gel removes volatile components including water and any residual acetic acid from the gel matrix while preserving the three-dimensional porous network structure established during the gelation step 825. The vacuum environment accelerates the removal of volatile components while preventing oxidation of the organic surfactant template during the initial drying stage. In some preferred embodiments, the overnight drying time ensures sufficient removal of residual solvents from the gel matrix while the solid wax-like consistency indicates that the gel has been adequately dried for subsequent thermal treatment. As illustrated in FIG. 8, step 830 prepares the BM gel for the intermediate heating step 835 by removing residual solvents that would otherwise interfere with the thermal consolidation process. In another preferred embodiment, the vacuum oven drying at 60° C. (333 K) provides gentle thermal treatment that removes volatile components without causing thermal decomposition of the boron-melamine network or premature removal of the surfactant template.

During step 835, the dried BM gel may be further heated for four hours at 200° C. (473 K) in a vacuum oven to initiate thermal consolidation of the composite structure while beginning the removal of surfactant residues from the particle matrix. In a preferred embodiment, step 835 corresponds to heating dried gel at 200° C. for 4 hours, where the intermediate heating step of heating the dried gel at approximately 200° C. for approximately four hours prior to calcining at the temperature ranging from 500° C. to 600° C. facilitates partial decomposition of the Pluronic-123 surfactant template and initial consolidation of the boron-melamine framework. The four-hour hold time at 200° C. (473 K) ensures sufficient thermal treatment for partial removal of the organic surfactant components while preserving the mesoporous morphology that will be further developed during the high-temperature calcination step. In some preferred embodiments, when using a furnace, the temperature may be increased at a rate of 2° C. per minute to reach 200° C. (473 K), maintained for four hours, and then allowed to cool to room temperature. As illustrated in FIG. 8, step 835 prepares the composite material for the subsequent washing step 840 by partially consolidating the structure and initiating the removal of surfactant residues. In another preferred embodiment, the controlled heating rate prevents thermal shock and maintains structural integrity of the developing boron-melamine composite particles during the intermediate consolidation process.

During step 840, the solid product may be washed with hot deionized water at approximately 70° C. (343 K) to remove any residual impurities or unreacted components from the particle matrix. In a preferred embodiment, the hot water washing at 70° C. (343 K) enhances the solubility of residual surfactant decomposition products and unreacted precursor materials, facilitating their removal from the porous structure of the composite particles. The washing process may be repeated until the wash water becomes clear, indicating removal of soluble contaminants and reaction byproducts from the boron-melamine composite matrix. In some preferred embodiments, the hot deionized water washing removes ionic impurities including sodium species and residual organic decomposition products that could otherwise remain in the porous structure and affect the surface chemistry of the final product. As illustrated in FIG. 8, step 840 purifies the thermally treated composite particles by removing residual reagents and surfactant decomposition products from the particle surfaces and pore structure. In another preferred embodiment, the use of hot water at 70° C. (343 K) rather than room temperature water improves the efficiency of the washing process by increasing the solubility of organic residues and accelerating the diffusion of impurities from the internal pore structure.

During step 845, the washed solid particles may be dried overnight in a vacuum oven at 60° C. (333 K) to obtain solid composite particles with reduced moisture content prior to high-temperature calcination. In a preferred embodiment, the overnight drying time ensures complete removal of absorbed water from both the external surfaces and the internal pore structure of the composite particles, preparing the material for the calcination step 850 where the final mesoporous structure will be developed. The vacuum environment accelerates the removal of residual moisture while preventing reabsorption of water vapor from the ambient atmosphere during the drying process. In some preferred embodiments, the drying temperature of 60° C. (333 K) provides sufficient thermal energy for water evaporation while avoiding thermal decomposition of any remaining organic components in the composite matrix. As illustrated in FIG. 8, step 845 prepares the washed composite particles for the calcination step 850 by ensuring that the material is free of moisture that could interfere with the high-temperature thermal treatment. In another preferred embodiment, the dried composite particles may be stored in a desiccator prior to calcination to prevent moisture reabsorption from the ambient atmosphere.

During step 850, the dried mass may be calcined at 600° C. (873 K) for four hours using an environment-controlled furnace to obtain the activated BM-600 particles with mesoporous structure and active surface sites for germanium adsorption. In a preferred embodiment, step 850 corresponds to calcining at 600° C. for 4 hours to obtain BM-600, where the calcining the dried gel at a temperature of at least 500° C. removes remaining organic matter including surfactant residues and develops the final mesoporous structure with active surface sites for germanium adsorption from acidic aqueous solutions. The calcining the dried gel comprises heating at a temperature ranging from 500° C. to 600° C. for approximately four hours under a nitrogen environment, which prevents oxidation of the composite material while allowing development of the crystalline boron-melamine phase. In some preferred embodiments, the controlled temperature ramp rate of 4° C. per minute prevents thermal shock and maintains structural integrity of the porous composite material during the high-temperature calcination process. As illustrated in FIG. 8, step 855 indicates the termination of the method 800 following completion of the calcination step 850 to produce the activated BM-600 composite particles. In another preferred embodiment, the boron-melamine composite material (BM-600) exhibits a germanium uptake capacity of 3.69 mg Ge/g and a gallium uptake capacity of 1.35 mg Ga/g from a binary mixture in 0.05 M HCl, demonstrating that the BM-600 composite adsorbs both germanium and gallium from acidic aqueous solutions due to the presence of nitrogen donor atoms in the melamine component that interact with both metal ion species.

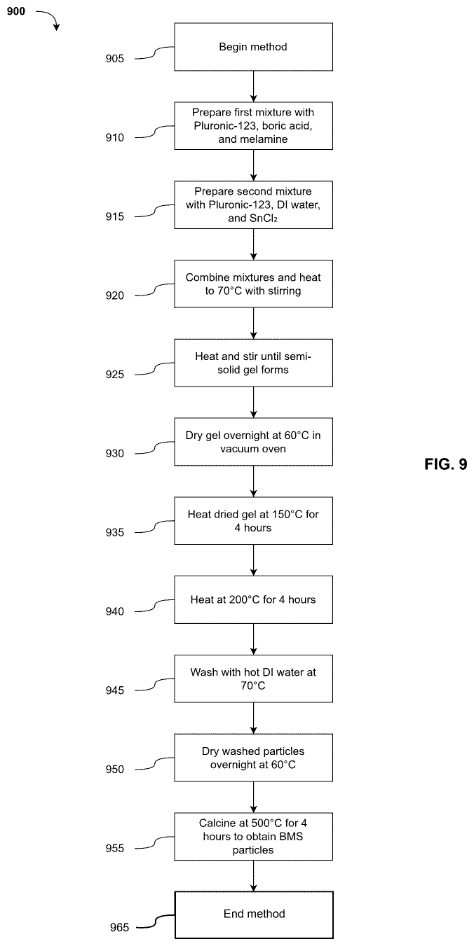

Referring to FIG. 9, a flowchart illustrates a method 900 of preparing a BMS (metal ion-doped Boron-Melamine-Tin) mesoporous composite resin for selective germanium removal from aqueous solutions using a two-step synthesis process where metal ion dopants are incorporated into the boron-melamine matrix through surfactant-templated sol-gel techniques. In a preferred embodiment, the method 900 begins at step 905, which indicates the beginning of the method 900 for preparing the mesoporous boron-based composite material with a boron-containing matrix derived from boric acid, a nitrogen-containing component derived from melamine incorporated into the boron-containing matrix, and a metal dopant comprising tin dispersed within the boron-containing matrix. The method 900 proceeds through sequential processing steps that establish separate precursor mixtures containing the surfactant template, boron and melamine components, and tin dopant, which are then combined and thermally treated to produce the mesoporous composite structure with active surface sites for germanium adsorption. In some preferred embodiments, the method 900 employs a two-step synthesis process where the first mixture is prepared by dissolving Pluronic-123 in water and grinding with boric acid and melamine in a mortar with pestle, while the second mixture is prepared separately with the tin dopant. As illustrated in FIG. 9, the method 900 includes steps for preparing the first mixture with grinding, preparing the second mixture with stannous chloride, combining and heating the mixtures, gelation, multiple drying and heating stages, hot water washing, and calcination to produce activated BMS composite particles with selective adsorption characteristics. In another preferred embodiment, the method 900 produces a mesoporous boron-based composite material wherein the composite material exhibits selective adsorption of germanium over gallium from acidic aqueous solutions containing 0.05 M hydrochloric acid. In yet another preferred embodiment, titanium doped variants of the mesoporous boron-based composite material may be prepared using titanium isopropoxide solution with ethanol instead of stannous chloride to incorporate titanium into the boron-melamine matrix. In some embodiments, magnesium doped variants may also be employed following a similar process to the BMS preparation process to achieve desired material properties for selective germanium adsorption.

During step 910, a first mixture may be prepared by dissolving 0.25 g of triblock copolymer surfactant Pluronic-123 (E020P070E020) in 20 mL of deionized (DI) water, and the resulting solution may then be transferred to a mortar where a measured amount of boric acid may be added slowly with constant grinding using a pestle until the components are mixed completely. In a preferred embodiment, the mesoporous boron-based composite material further comprises a surfactant template derived from a triblock copolymer, wherein the triblock copolymer comprises Pluronic-123, which serves as a template for developing the mesoporous structure during the sol-gel synthesis process. The boric acid serves as the boron source for the boron-containing matrix derived from boric acid, while the grinding action ensures intimate mixing of the boric acid with the surfactant solution to promote uniform distribution throughout the developing composite matrix. In some preferred embodiments, a measured amount of melamine (C3H6N6) may then be added to the mortar and mixed under constant grinding to form a homogeneous boron-melamine precursor mixture, where the melamine provides the nitrogen-containing component derived from melamine incorporated into the boron-containing matrix. As illustrated in FIG. 9, step 910 establishes the first mixture containing the surfactant, boric acid, and melamine components that will be combined with the tin-containing second mixture in the subsequent step 920. In another preferred embodiment, the grinding process in the mortar with pestle ensures thorough mixing of the solid boric acid and melamine components with the surfactant solution, promoting homogeneous distribution of all precursor materials throughout the first mixture. In yet another preferred embodiment, for titanium doped variants, the first mixture preparation remains substantially the same, with the titanium dopant being introduced in the second mixture preparation step using titanium isopropoxide as the titanium source.

During step 915, a second mixture may be prepared separately by combining 0.25 g of Pluronic-123, 10.0 mL of deionized (DI) water, and a measured amount of stannous chloride (SnCl₂) in a separate mortar. In a preferred embodiment, the tin is derived from stannous chloride, and the metal dopant comprises tin derived from stannous chloride, which will be incorporated into the boron-melamine matrix to enhance selective germanium adsorption characteristics. The components may be continuously ground with a pestle to ensure thorough mixing and uniform distribution of the tin species throughout the surfactant solution in the second mixture. In some preferred embodiments, the method 900 uses 0.25 g of Pluronic-123 surfactant in each of the two preparation steps for a total of 0.5 g surfactant, with the second mixture using 10.0 mL of deionized water to dissolve the stannous chloride component. As illustrated in FIG. 9, step 915 prepares the tin-containing second mixture that will be combined with the first mixture from step 910 to incorporate the metal dopant into the boron-melamine composite matrix. In another preferred embodiment, adding the metal dopant comprises preparing a separate mixture of the surfactant, deionized water, and stannous chloride, which allows for controlled incorporation of the tin species into the developing composite structure when the two mixtures are combined in the subsequent step 920. In yet another preferred embodiment, for titanium doped variants, the second mixture may be prepared by combining 0.25 g of Pluronic-123, ethanol as the solvent, and a measured amount of titanium isopropoxide instead of stannous chloride, where the titanium isopropoxide serves as the titanium source for incorporating titanium into the boron-melamine matrix. In some embodiments, for magnesium doped variants, a magnesium salt such as magnesium chloride may be used in place of stannous chloride following a similar preparation process to incorporate magnesium into the boron-melamine matrix.

During step 920, the ground mixture from step 915 may be added to the solution from step 910 with gentle stirring to combine the boron-melamine precursor with the tin dopant, and the combined mixture may then be heated from room temperature to 70° C. (343 K) using a water bath under vigorous stirring for approximately one hour to obtain a clear solution. In a preferred embodiment, adding the metal dopant further comprises combining the separate mixture with the boric acid-surfactant solution and the melamine solution, where the gentle stirring ensures uniform distribution of the tin dopant throughout the boron-melamine precursor mixture. The heating to 70° C. (343 K) accelerates the polymerization reactions between the boric acid and melamine components while the tin species become incorporated into the developing network structure. In some preferred embodiments, a molar ratio of boric acid to melamine to tin chloride in the composite material is approximately 0.015:7.54×10-3:0.045, and the molar ratio of Pluronic-123, boric acid, melamine, and tin chloride (SnCl₂) in the solution may be6.89×10⁻⁵:0.015:7.54×10⁻³:0.045, respectively, as these ratios were established through optimization to achieve desired mesoporous characteristics and germanium adsorption performance. As illustrated in FIG. 9, step 920 combines the two separately prepared mixtures and initiates the thermal treatment that will lead to gel formation in the subsequent step 925. In another preferred embodiment, the vigorous stirring during the one-hour heating period ensures uniform mixing of all components including the boric acid, melamine, tin dopant, and surfactant template throughout the combined solution. In yet another preferred embodiment, for titanium doped variants, the titanium isopropoxide-containing second mixture is combined with the boron-melamine first mixture under similar heating and stirring conditions, where the titanium species undergo hydrolysis and condensation reactions to become incorporated into the boron-melamine network structure. In some embodiments, for magnesium doped variants, the magnesium-containing second mixture may be combined with the boron-melamine first mixture following a similar process to achieve uniform distribution of the magnesium dopant throughout the composite matrix.

During step 925, the combined mixture may be maintained under continuous heating and stirring until a semi-solid gel forms, with the gelation process indicating the formation of a boron-melamine-tin network structure through sol-gel polymerization of the precursor components with the incorporated tin dopant. In a preferred embodiment, the onset of gelation indicates that the polymerization reactions between the boric acid and melamine components have progressed sufficiently to form a continuous three-dimensional network structure with the tin dopant dispersed throughout the matrix. The heating the combined mixture to form a gel establishes the porous structure that will be retained through subsequent drying and calcination steps to produce the final mesoporous boron-melamine-tin composite material. In some preferred embodiments, the continuous stirring during the gelation process ensures uniform distribution of the tin dopant and surfactant template throughout the gel matrix, which will develop into the mesoporous morphology during the thermal treatment steps. As illustrated in FIG. 9, step 925 represents the transition from the liquid sol phase to the semi-solid gel phase that characterizes the sol-gel synthesis approach for preparing the tin-doped boron-melamine composite material. In another preferred embodiment, the gelation process proceeds under the continued heating at 70° C. (343 K) until the mixture transforms into a semi-solid consistency suitable for the subsequent drying steps. In yet another preferred embodiment, for titanium doped variants, the gelation process forms a boron-melamine-titanium network structure where the titanium species are incorporated into the three-dimensional matrix through hydrolysis and condensation reactions of the titanium isopropoxide precursor. In some embodiments, for magnesium doped variants, the gelation process may proceed similarly to form a boron-melamine-magnesium network structure with the magnesium dopant dispersed throughout the matrix.

During step 930, the semi-solid gel may be heated overnight at 60° C. (333 K) in a vacuum oven to produce a solid wax-like gel designated as boron-melamine-tin (BMS) gel. In a preferred embodiment, the vacuum environment accelerates the removal of volatile components including water from the gel matrix while preventing oxidation of the tin species during the initial drying stage. The overnight drying time ensures sufficient removal of residual solvents from the gel matrix while preserving the three-dimensional porous network structure established during the gelation step 925. In some preferred embodiments, the solid wax-like BMS gel retains the tin dopant uniformly distributed throughout the boron-melamine matrix, which will be further consolidated through subsequent heat treatment steps at progressively higher temperatures. As illustrated in FIG. 9, step 930 prepares the BMS gel for the intermediate heating step 935 by removing residual solvents that would otherwise interfere with the thermal consolidation process. In another preferred embodiment, the drying the gel to form a dried gel at 60° C. (333 K) provides gentle thermal treatment that removes volatile components without causing thermal decomposition of the boron-melamine network or oxidation of the tin dopant species. In yet another preferred embodiment, for titanium doped variants, the semi-solid gel may be dried under similar conditions to produce a solid wax-like boron-melamine-titanium (BMT) gel, where the vacuum environment prevents oxidation of the titanium species during the drying stage. In some embodiments, for magnesium doped variants, the drying process may proceed similarly to produce a boron-melamine-magnesium gel with the magnesium dopant retained in the matrix.

During step 935, the dried BMS gel may be further heated for four hours at 150° C. (423 K) in a vacuum oven and then cooled to room temperature, with the method 900 including an intermediate heating step at 150° C. (423 K) for four hours prior to heating at 200° C. (473 K). In a preferred embodiment, when using a furnace, the temperature may be increased at a rate of 2° C. per minute to reach 150° C. (423 K), maintained for four hours, and then allowed to cool to room temperature, where the method 900 uses a temperature ramp rate of 2° C. per minute when heating the dried gel at 150° C. and 200° C. in a furnace. The intermediate heating step 935 facilitates partial consolidation of the composite structure while beginning the removal of surfactant residues from the particle matrix without causing thermal shock to the developing porous structure. In some preferred embodiments, the controlled heating rate of 2° C. per minute prevents thermal stress and maintains structural integrity of the developing tin-doped boron-melamine composite particles during the intermediate consolidation process. As illustrated in FIG. 9, step 935 prepares the composite material for the subsequent heating step 940 by partially consolidating the structure and initiating the removal of organic surfactant components. In another preferred embodiment, the four-hour hold time at 150° C. (423 K) ensures sufficient thermal treatment for partial decomposition of the Pluronic-123 surfactant template while preserving the mesoporous morphology that will be further developed during subsequent higher-temperature treatment steps. In yet another preferred embodiment, for titanium doped variants, the intermediate heating step may be performed under similar conditions to facilitate partial consolidation of the boron-melamine-titanium composite structure. In some embodiments, for magnesium doped variants, the intermediate heating process may proceed similarly to consolidate the boron-melamine-magnesium composite structure.

During step 940, the dried BMS gel may be further heated for four hours at 200° C. (473 K) in a vacuum oven to continue the thermal consolidation process and facilitate the formation of solid composite particulate materials. In a preferred embodiment, when using a furnace, the temperature may be increased at a rate of 2° C. per minute to reach 200° C. (473 K), maintained for four hours, and then allowed to cool to room temperature, consistent with the temperature ramp rate used in step 935. The heat treatment process at 200° C. (473 K) burns off chemical contaminants such as surfactant residues efficiently from the particle matrix while facilitating the formation of solid composite particulate materials with the tin dopant incorporated into the boron-melamine framework. In some preferred embodiments, the controlled heating rate prevents thermal stress and maintains structural integrity of the developing composite particles while allowing gradual removal of organic components from the gel matrix. As illustrated in FIG. 9, step 940 produces solid BMS particles through thermal consolidation of the gel matrix with the tin dopant incorporated into the boron-melamine network structure. In another preferred embodiment, the four-hour hold time at 200° C. (473 K) ensures sufficient thermal treatment for consolidation of the composite structure and continued development of the mesoporous morphology. In yet another preferred embodiment, for titanium doped variants, the heating at 200° C. (473 K) facilitates the formation of solid boron-melamine-titanium composite particulate materials with the titanium dopant incorporated into the framework structure. In some embodiments, for magnesium doped variants, the thermal consolidation process may proceed similarly to produce solid boron-melamine-magnesium composite particles.

During step 945, the solid product may be washed with hot deionized water at approximately 70° C. (343 K) to remove any residual impurities or unreacted components from the particle matrix. In a preferred embodiment, the hot water washing at 70° C. (343 K) enhances the solubility of residual surfactant decomposition products and unreacted precursor materials, facilitating their removal from the porous structure of the BMS composite particles. The washing process may be repeated until the wash water becomes clear, indicating removal of soluble contaminants and reaction byproducts from the boron-melamine-tin composite matrix. In some preferred embodiments, the hot deionized water washing removes ionic impurities and residual organic decomposition products that could otherwise remain in the porous structure and affect the surface chemistry of the final product. As illustrated in FIG. 9, step 945 purifies the thermally treated BMS composite particles by removing residual reagents and surfactant decomposition products from the particle surfaces and pore structure. In another preferred embodiment, the use of hot water at 70° C. (343 K) rather than room temperature water improves the efficiency of the washing process by increasing the solubility of organic residues and accelerating the diffusion of impurities from the internal pore structure of the mesoporous composite particles. In yet another preferred embodiment, for titanium doped variants, the hot water washing process may be performed under similar conditions to remove residual impurities from the boron-melamine-titanium composite particles. In some embodiments, for magnesium doped variants, the washing process may proceed similarly to purify the boron-melamine-magnesium composite particles.

During step 950, the washed solid particles may be dried overnight at 60° C. (333 K) to obtain solid composite particles with reduced moisture content prior to high-temperature calcination. In a preferred embodiment, the overnight drying time ensures complete removal of absorbed water from both the external surfaces and the internal pore structure of the BMS composite particles, preparing the material for the calcination step 955 where the final mesoporous structure will be developed. The vacuum environment may be employed during the drying process to accelerate moisture removal while preventing oxidation of the tin species in the composite matrix. In some preferred embodiments, the drying temperature of 60° C. (333 K) provides sufficient thermal energy for water evaporation while avoiding thermal decomposition of any remaining organic components in the composite matrix. As illustrated in FIG. 9, step 950 prepares the washed BMS composite particles for the calcination step 955 by ensuring that the material is free of moisture that could interfere with the high-temperature thermal treatment. In another preferred embodiment, the dried BMS composite particles may be stored in a desiccator prior to calcination to prevent moisture reabsorption from the ambient atmosphere. In yet another preferred embodiment, for titanium doped variants, the drying process may be performed under similar conditions to prepare the boron-melamine-titanium composite particles for calcination. In some embodiments, for magnesium doped variants, the drying process may proceed similarly to prepare the boron-melamine-magnesium composite particles for high-temperature thermal treatment.

During step 955, the dried mass may be further heat-treated for four hours using an environment-controlled furnace at 500° C. (773 K) at a heating ramp rate of 4° C. per minute to burn off any residual hydrocarbon that may be present in the composite matrix, where the method 900 calcines the dried mass at 500° C. (773 K) for four hours at a heating ramp rate of 4° C. per minute to burn off residual hydrocarbon. In a preferred embodiment, the composite material is calcined at a temperature ranging from 500° C. to 600° C., and the resulting material may be designated as activated BMS particles, with the multiple stages of drying, heating, and cooling stabilizing the reaction of tin with the boron and melamine components while facilitating pore formation in the activated BMS composite matrix. The controlled temperature ramp rate of 4° C. per minute prevents thermal shock and maintains structural integrity of the porous composite material during the high-temperature calcination process. In some preferred embodiments, the possible overall polymerization reaction among the components may be expressed as: C₃H₆N₆+2H₃BO₃+6SnCl₂+6H₂O →2B(N₂HSnO)₃+12HCl+3CO₂↑+3H₂↑, which represents the formation of the tin-doped boron-melamine network structure with the release of gaseous byproducts. As illustrated in FIG. 9, step 955 produces the activated BMS particles through calcination at 500° C. (773 K), which falls within the temperature range of 500° C. to 600° C. specified for producing stable mesoporous boron-based composite materials. In another preferred embodiment, the mesoporous boron-based composite material can be doped with titanium (Ti) using titanium isopropoxide solution with ethanol instead of stannous chloride, where the titanium doped variant may be designated as BMT and exhibits enhanced stability and germanium adsorption characteristics due to the incorporation of titanium into the boron-melamine matrix. In yet another preferred embodiment, the mesoporous boron-based composite material can be doped with magnesium (Mg) following a similar process to the BMS preparation process, where the magnesium doped variant may provide alternative adsorption characteristics for selective germanium removal from acidic aqueous solutions, demonstrating the versatility of the method 900 for incorporating different metal dopants into the boron-melamine matrix.

The method 900 may optionally include further calcining the BMS composite particles in a furnace at 600° C. (873 K) at a rate of 4° C. per minute temperature increase, maintained for four hours under nitrogen environment, and then cooled to room temperature to obtain the activated BMS-600 composite. In a preferred embodiment, the composite material is calcined at approximately 600° C. for approximately four hours under a nitrogen environment, which prevents oxidation of the tin species during high-temperature calcination while developing the final mesoporous structure with active surface sites suitable for germanium adsorption from acidic solutions. The nitrogen environment during the calcination at 600° C. (873 K) maintains the oxidation state of the tin dopant while allowing complete removal of organic surfactant residues and development of the crystalline boron-melamine-tin phase. In some preferred embodiments, the performance of the activated BMS-600 composite particles may be evaluated for germanium and gallium ions uptake from a binary mixture of Ge and Ga in 0.05 M HCl solutions, where the composite material exhibits selective adsorption of germanium over gallium from acidic aqueous solutions. As illustrated in FIG. 9, step 965 indicates the termination of the method 900 following completion of the calcination step 955 or the optional high-temperature treatment at 600° C. (873 K) to produce the BMS-600 variant. In another preferred embodiment, the BMS-600composite resin exhibits a germanium uptake capacity of 1.21 mg Ge/g of resin with substantially no gallium uptake from a binary mixture in 0.05 M HCl, demonstrating that the tin-doped boron-melamine composite material achieves selective germanium adsorption over gallium due to the oxidation of tin species (Sn2+/Sn4+) in the activated matrix that converts lower valence metallic ions to higher valence states. In yet another preferred embodiment, for titanium doped variants, the calcination at 600° C. (873 K) under nitrogen environment produces activated BMT-600 composite particles with titanium incorporated into the boron-melamine matrix, where the titanium doped variant may exhibit enhanced stability and selective germanium adsorption characteristics. In some embodiments, for magnesium doped variants, the calcination process may proceed similarly to produce activated boron-melamine-magnesium composite particles with the magnesium dopant incorporated into the matrix structure.

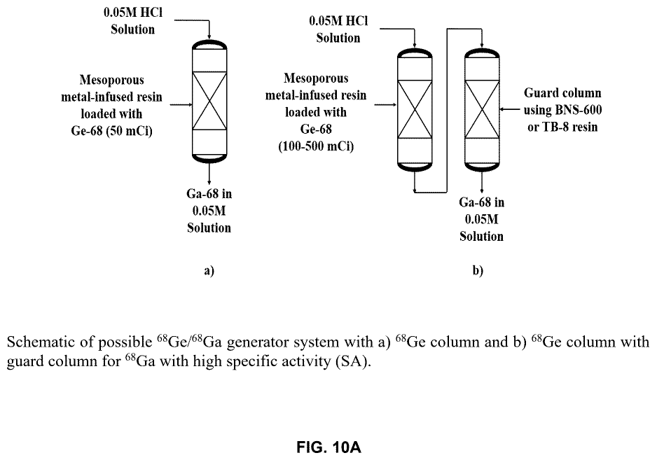

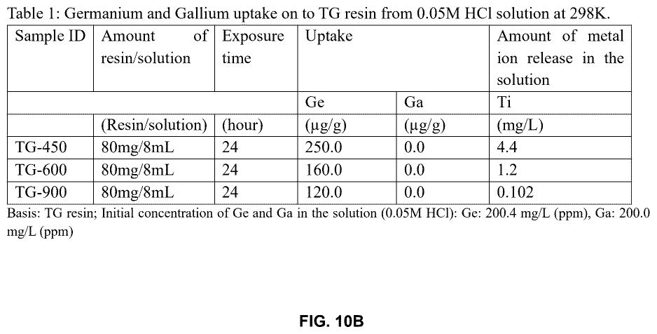

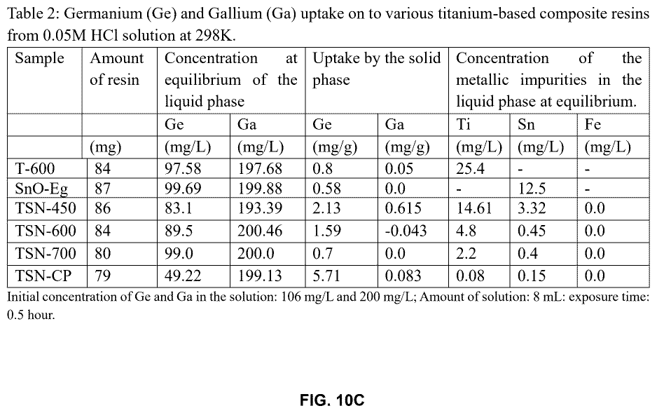

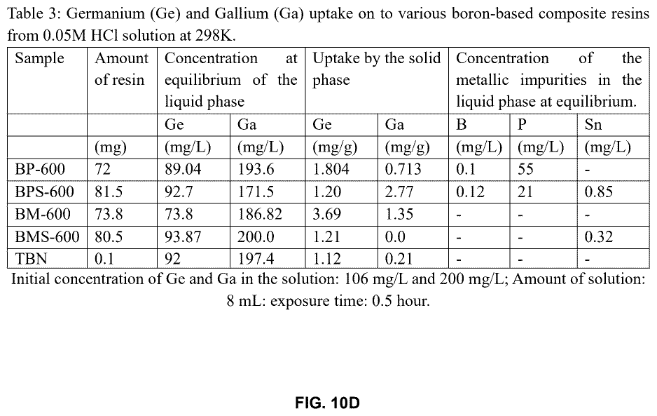

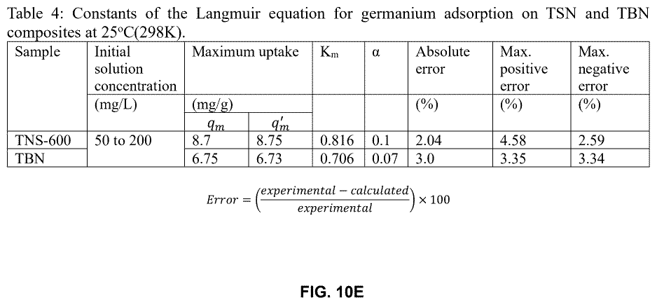

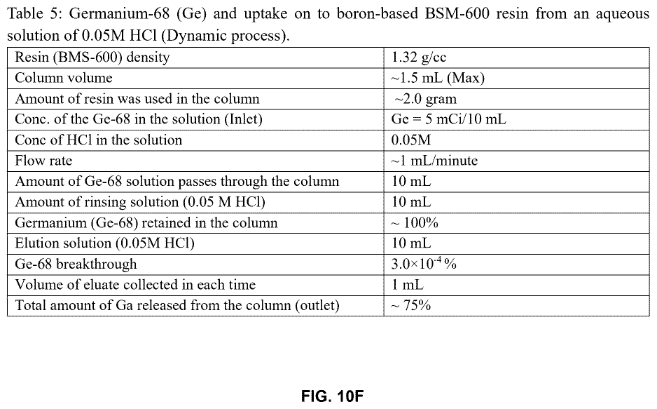

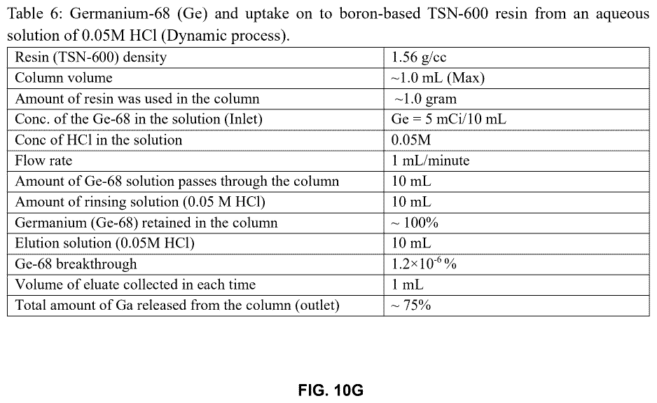

Referring to FIG. 10A, a system diagram illustrates the configuration of a Ge-68/Ga-68 radionuclide generator using composite resin material for selective germanium removal from aqueous solutions. In a preferred embodiment, the diagram depicts two generator configurations labeled as configuration a) and configuration b), which represent different approaches for producing Ga-68 for radiopharmaceutical applications. Configuration a) shows a single column system comprising a mesoporous metal-infused resin column loaded with Ge-68 at 50 mCi activity, where the column receives 0.05 M HCl solution as the inlet eluent at the top of the column. The Ge-68 radionuclide is retained on the mesoporous metal-infused resin while the daughter product Ga-68 is eluted from the bottom of the column in 0.05 M solution for subsequent radiopharmaceutical applications. In some preferred embodiments, the single column configuration provides a straightforward approach for Ga-68 production where the activity requirements are moderate and the radionuclidic purity specifications can be met with a single separation stage. As illustrated in FIG. 10A, the single column system demonstrates the fundamental operating principle of the Ge-68/Ga-68 generator where the parent radionuclide remains bound to the composite resin while the daughter radionuclide is selectively eluted. Configuration b) depicted in FIG. 10A shows a dual column system designed for high specific activity Ga-68 production from higher activity Ge-68 sources. In a preferred embodiment, the first column comprises a mesoporous metal-infused resin loaded with Ge-68 at higher activity levels ranging from 100 to 500 mCi, which provides increased Ga-68 production capacity compared to the single column configuration. The first column receives 0.05 M HCl solution as the inlet eluent at the top, and the effluent from the first column flows into a second column designated as a guard column. In some preferred embodiments, the guard column uses BNS-600 or TB-8 resin to further purify the Ga-68 eluate by removing any Ge-68 breakthrough that may occur from the primary generator column during the elution process. The purified Ga-68 in 0.05 M solution exits from the bottom of the guard column system with enhanced radionuclidic purity suitable for radiopharmaceutical preparation. In another preferred embodiment, the dual column configuration with the guard column provides enhanced radionuclidic purity of the Ga-68 product by capturing any Ge-68 that may elute from the primary mesoporous metal-infused resin column, which is particularly advantageous when operating with higher activity Ge-68 sources where even small percentage breakthrough could result in unacceptable Ge-68 contamination in the final product.

As illustrated in FIG. 10A, both generator configurations utilize the selective adsorption characteristics of the mesoporous composite resin materials described herein to achieve separation of germanium and gallium radionuclides. In a preferred embodiment, the mesoporous metal-infused resin in the primary column may comprise any of the composite materials described in the present disclosure, including the TSN-600 titanium-based composite or the BMS-600 boron-based composite, which exhibit selective adsorption of germanium over gallium from acidic aqueous solutions. The 0.05 M HCl eluent concentration corresponds to the acidic conditions under which the composite resin materials have been demonstrated to exhibit selective germanium retention while allowing gallium to pass through substantially unretained. In some preferred embodiments, the flow rate through the generator columns may be maintained at approximately 1 mL per minute to provide adequate contact time between the eluent and the composite resin for efficient Ga-68 elution while minimizing Ge-68 breakthrough. The generator system configurations depicted in FIG. 10A enable the production of Ga-68 chloride suitable for use in developing targeted PET radiopharmaceuticals through the selective separation of the daughter radionuclide from the parent Ge-68 bound to the composite resin matrix. In another preferred embodiment, the generator systems may be operated repeatedly over the useful lifetime of the Ge-68 source, with the composite resin materials exhibiting resistance to radiation exposure and acidic conditions without substantial physical degradation of the composite resin structure.

As illustrated in FIG. 10B, Table 1 presents data for germanium and gallium uptake onto TG resin from 0.05 M HCl solution at 298 K, demonstrating the selective adsorption characteristics of the titanium-glucose composite materials prepared at different calcination temperatures. In a preferred embodiment, the table includes columns for Sample ID, Amount of resin/solution, Exposure time, Uptake values for both germanium and gallium expressed in micrograms per gram, and Amount of metal ion release in the solution expressed as titanium concentration in milligrams per liter. The table presents data for three TG resin samples designated as TG-450, TG-600, and TG-900, where each sample uses 80 mg of resin per 8 mL of solution with an exposure time of 24 hours under the specified acidic conditions. In some preferred embodiments, the initial concentration of germanium and gallium in the 0.05 M HCl solution was 200.4 mg/L Ge and 200.0 mg/L Ga, providing a binary mixture for evaluating the selective adsorption performance of the composite materials. The germanium uptake values are 250.0, 160.0, and 120.0 micrograms per gram for TG-450, TG-600, and TG-900 respectively, indicating that lower calcination temperatures produce composite materials with higher germanium uptake capacity. In another preferred embodiment, the gallium uptake is 0.0 micrograms per gram for all three samples, demonstrating that the TG composite materials exhibit selective adsorption of germanium while rejecting gallium from the acidic aqueous solution.

The titanium release data presented in Table 1 of FIG. 10B provides information regarding the stability of the TG composite materials under acidic conditions during the adsorption process. In a preferred embodiment, the titanium release to solution is 4.4, 1.2, and 0.102 milligrams per liter for TG-450, TG-600, and TG-900 respectively, demonstrating that higher calcination temperatures produce more stable composite materials with reduced metal ion dissolution in the 0.05 M HCl solution. The inverse relationship between calcination temperature and titanium release indicates that the thermal treatment at elevated temperatures consolidates the titanium oxide matrix and reduces its susceptibility to dissolution under acidic conditions. In some preferred embodiments, the TG-900 composite resin exhibits the lowest titanium release of only 0.102 mg/L while maintaining a germanium uptake capacity of 120 μg Ge/g, representing a balance between matrix stability and adsorption performance. The data in Table 1 demonstrates that the selection between TG-450, TG-600, and TG-900 variants may depend on the specific application requirements balancing germanium uptake capacity against matrix stability in acidic environments. In another preferred embodiment, the TG-450 composite provides the highest germanium uptake capacity of 250 μg Ge/g but releases more titanium to the solution, which may be acceptable for applications where matrix stability is less constrained than adsorption capacity requirements.

As illustrated in FIG. 10C, Table 2 presents data for germanium and gallium uptake onto various titanium-based composite resins from 0.05 M HCl solution at 298 K, providing a comprehensive comparison of the adsorption performance and stability characteristics across different composite formulations. In a preferred embodiment, the table includes columns for sample identification, amount of resin in milligrams, concentration at equilibrium of the liquid phase for both germanium and gallium in mg/L, uptake by the solid phase for both germanium and gallium in mg/g, and concentration of metallic impurities in the liquid phase at equilibrium for titanium, tin, and iron in mg/L. The table presents data for six different resin samples designated as T-600, SnO-Eg, TSN-450, TSN-600, TSN-700, and TSN-CP, enabling direct comparison of the adsorption characteristics and matrix stability among the various titanium-based composite formulations. In some preferred embodiments, the initial concentration of germanium and gallium in the solution was 106 mg/L and 200 mg/L respectively, with an amount of solution of 8 mL and an exposure time of 0.5 hour, providing standardized conditions for evaluating the comparative performance of the different composite materials. The data in Table 2 demonstrates the effect of calcination temperature and surface modification on both germanium uptake capacity and metallic impurity release from the titanium-based composite matrices. In another preferred embodiment, the TSN-CP sample exhibits the highest germanium uptake of 5.71 mg/g among all samples tested while releasing only 0.08 mg/L titanium and 0.15 mg/L tin to the solution, demonstrating that the catechol-TEPA crosslinking modification enhances both adsorption capacity and matrix stability.

The T-600 sample data presented in Table 2 of FIG. 10C shows a germanium uptake of 0.8 mg/g and a gallium uptake of 0.05 mg/g, with a titanium impurity concentration of 25.4 mg/L and no detectable tin or iron in the solution. In a preferred embodiment, the SnO-Eg sample exhibits a germanium uptake of 0.58 mg/g with no gallium uptake, releasing 12.5 mg/L tin to the solution with no detectable titanium or iron, indicating that the tin oxide-ethylene glycol composite provides selective germanium adsorption but with significant tin dissolution under acidic conditions. The TSN-450 sample shows a germanium uptake of 2.13 mg/g and a gallium uptake of 0.615 mg/g, with titanium and tin impurity concentrations of 14.61 mg/L and 3.32 mg/L respectively, demonstrating that the lower calcination temperature produces a composite with higher germanium capacity but reduced selectivity and stability compared to higher temperature variants. In some preferred embodiments, the TSN-600 sample exhibits a germanium uptake of 1.59 mg/g with a negative gallium uptake value of −0.043 mg/g, indicating that gallium is not adsorbed and the composite material exhibits selective germanium retention while releasing only 4.8 mg/L titanium and 0.45 mg/L tin to the solution. The TSN-700 sample shows a germanium uptake of 0.7 mg/g with no gallium uptake, releasing 2.2 mg/L titanium and 0.4 mg/L tin, demonstrating that the higher calcination temperature produces a more stable matrix with reduced metal ion dissolution but lower germanium uptake capacity. In another preferred embodiment, the progressive decrease in metallic impurity release from TSN-450 to TSN-600 to TSN-700 confirms that higher calcination temperatures consolidate the titanium-tin oxide matrix and reduce its susceptibility to dissolution under the 0.05 M HCl conditions used in the adsorption experiments.

As illustrated in FIG. 10D, Table 3 presents data for germanium and gallium uptake onto various boron-based composite resins from 0.05 M HCl solution at 298 K, providing a comprehensive comparison of the adsorption performance and stability characteristics across different boron-based composite formulations. In a preferred embodiment, the table includes columns for sample identification, amount of resin in milligrams, concentration at equilibrium of the liquid phase for germanium and gallium in mg/L, uptake by the solid phase for germanium and gallium in mg/g, and concentration of metallic impurities in the liquid phase at equilibrium for boron, phosphorus, and tin in mg/L. The table presents data for five different boron-based composite resin samples designated as BP-600, BPS-600, BM-600, BMS-600, and TBN, enabling direct comparison of the adsorption characteristics and matrix stability among the various boron-based composite formulations. In some preferred embodiments, the initial concentration of germanium and gallium in the solution was 106 mg/L and 200 mg/L respectively, with an amount of solution of 8 mL and an exposure time of 0.5 hour, providing standardized conditions for evaluating the comparative performance of the different boron-based composite materials. The data in Table 3 demonstrates the effect of composition and metal doping on both germanium uptake capacity and selectivity over gallium for the boron-based composite matrices. In another preferred embodiment, the BMS-600 sample exhibits a germanium uptake of 1.21 mg/g with 0.0 mg/g gallium uptake, demonstrating that the tin-doped boron-melamine composite material achieves selective germanium adsorption over gallium from the acidic aqueous solution.

The BP-600 sample data presented in Table 3 of FIG. 10D shows a germanium uptake of 1.804 mg/g and a gallium uptake of 0.713 mg/g, with metallic impurity concentrations of 0.1 mg/L boron and 55 mg/L phosphorus in the solution. In a preferred embodiment, the BPS-600 sample exhibits a germanium uptake of 1.20 mg/g and a gallium uptake of 2.77 mg/g, with metallic impurity concentrations of 0.12 mg/L boron, 21 mg/L phosphorus, and 0.85 mg/L tin, indicating that the tin-doped boron-phosphate composite adsorbs both germanium and gallium from the acidic solution without exhibiting selectivity for germanium. The BM-600 sample shows a germanium uptake of 3.69 mg/g and a gallium uptake of 1.35 mg/g, demonstrating that the boron-melamine composite without tin doping exhibits the highest germanium uptake capacity among the boron-based samples but also adsorbs gallium from the solution. In some preferred embodiments, the BMS-600 sample exhibits a germanium uptake of 1.21 mg/g with no gallium uptake and a tin impurity concentration of only 0.32 mg/L, confirming that the incorporation of tin dopant into the boron-melamine matrix provides selective germanium adsorption while maintaining matrix stability under acidic conditions. The TBN sample shows a germanium uptake of 1.12 mg/g and a gallium uptake of 0.21 mg/g, indicating moderate selectivity for germanium over gallium from the acidic aqueous solution. In another preferred embodiment, the comparison of BM-600 and BMS-600 samples demonstrates that the addition of tin dopant to the boron-melamine matrix reduces the overall germanium uptake capacity from 3.69 mg/g to 1.21 mg/g but eliminates gallium uptake entirely, thereby providing the selective adsorption characteristics desired for Ge-68/Ga-68 generator applications where germanium retention and gallium elution are required.

As illustrated in FIG. 10E, Table 4 presents constants of the Langmuir equation for germanium adsorption on TSN and TBN composites at 25° C. (298 K), providing quantitative parameters that characterize the adsorption behavior of these mesoporous composite materials. In a preferred embodiment, the table includes data for two sample types designated as TNS-600 and TBN, with an initial solution concentration range of 50 to 200 mg/L for the adsorption experiments. The table includes columns for maximum uptake expressed in mg/g with two sub-columns designated as qm and q'm, a column for Km values, a column for α values, a column for absolute error expressed as a percentage, a column for maximum positive error expressed as a percentage, and a column for maximum negative error expressed as a percentage. In some preferred embodiments, the Langmuir isotherm model parameters provide a mathematical framework for predicting germanium adsorption capacity at various equilibrium concentrations within the tested range. The error values presented in Table 4 quantify the deviation between experimental measurements and calculated values from the fitted Langmuir model, with the error calculation defined as the difference between experimental and calculated values divided by the experimental value, multiplied by 100. In another preferred embodiment, the close agreement between experimental and calculated maximum uptake values (qm and q'm) confirms that the Langmuir isotherm model provides an appropriate description of the germanium adsorption behavior on these mesoporous composite materials.

The TNS-600 sample data presented in Table 4 of FIG. 10E shows a qm value of 8.7 mg/g and a q'm value of 8.75 mg/g, with a Km value of 0.816 and an α value of 0.1, demonstrating favorable adsorption characteristics for germanium from the acidic aqueous solution. In a preferred embodiment, the absolute error for the TNS-600 sample is 2.04%, with a maximum positive error of 4.58% and a maximum negative error of 2.59%, indicating that the Langmuir model provides a good fit to the experimental adsorption data for this tin-doped titanium composite material. The TBN sample exhibits a qm value of 6.75 mg/g and a q'm value of 6.73 mg/g, with a Km value of 0.706 and an α value of 0.07, representing slightly lower maximum adsorption capacity compared to the TNS-600 composite. In some preferred embodiments, the absolute error for the TBN sample is 3.0%, with a maximum positive error of 3.35% and a maximum negative error of 3.34%, confirming that the Langmuir isotherm model also provides an acceptable fit for the boron-based composite material. The Km values for both samples indicate the affinity of the composite surfaces for germanium ions, with higher Km values corresponding to stronger binding interactions between the adsorbate and the adsorbent surface. In another preferred embodiment, the Langmuir isotherm parameters presented in Table 4 enable prediction of germanium uptake capacity at equilibrium concentrations within the tested range, which is useful for designing column configurations and determining appropriate resin bed volumes for Ge-68/Ga-68 generator applications where selective germanium retention is desired.

As illustrated in FIG. 10F, Table 5 presents data for Germanium-68 uptake onto boron-based BMS-600 resin from an aqueous solution of 0.05 M HCl in a dynamic process, providing operational parameters and performance characteristics for the composite material in a generator configuration. In a preferred embodiment, the table specifies that the resin density is 1.32 g/cc and the column volume is approximately 1.5 mL maximum, with an amount of resin used in the column of approximately 2.0 gram. The concentration of Ge-68 in the inlet solution is specified as Ge equals 5 mCi per 10 mL, with the concentration of HCl in the solution maintained at 0.05 M and a flow rate of approximately 1 mL per minute. In some preferred embodiments, the amount of Ge-68 solution passed through the column is 10 mL, and the amount of rinsing solution using 0.05 M HCl is also 10 mL, providing standardized conditions for evaluating the dynamic adsorption performance of the BMS-600 composite material. The data in Table 5 demonstrates that the germanium Ge-68 retained in the column is approximately 100 percent, confirming the effectiveness of the tin-doped boron-melamine composite for selective germanium retention under dynamic flow conditions. In another preferred embodiment, the elution solution using 0.05 M HCl is 10 mL, with the volume of eluate collected in each time being 1 mL, enabling fractionated collection of the gallium-containing eluate for radiopharmaceutical applications.

The performance metrics presented in Table 5 of FIG. 10F demonstrate the suitability of the BMS-600 composite resin for Ge-68/Ga-68 radionuclide generator applications where selective germanium retention and efficient gallium elution are required. In a preferred embodiment, the Ge-68 breakthrough is listed as 3.0 times 10 to the negative fourth power percent, indicating that the BMS-600 resin provides effective retention of the parent radionuclide with minimal leakage into the eluate stream during the elution process. The total amount of Ga released from the column at the outlet is approximately 75 percent, demonstrating that the composite material allows efficient elution of the daughter Ga-68 radionuclide while maintaining selective retention of the parent Ge-68 on the resin bed. In some preferred embodiments, the combination of high germanium retention and efficient gallium elution observed in Table 5 confirms that the BMS-600 composite material exhibits the selective adsorption characteristics desired for generator applications where radionuclidic purity of the Ga-68 product is required. The dynamic process parameters specified in Table 5 provide a framework for scaling the generator system to accommodate different activity levels and production requirements. In another preferred embodiment, the experimental data presented in Table 5 supports the use of the mesoporous boron-based composite material comprising a boron-containing matrix, a nitrogen-containing component derived from melamine, and a tin dopant for selective germanium removal from aqueous solutions in radionuclide generator configurations.

As illustrated in FIG. 10G, Table 6 presents data for Germanium-68 uptake onto titanium-based TSN-600 resin from an aqueous solution of 0.05 M HCl in a dynamic process, providing operational parameters and performance characteristics for the tin-doped titanium composite material in a generator configuration. In a preferred embodiment, the table specifies that the resin density is 1.56 g/cc and the column volume is approximately 1.0 mL maximum, with an amount of resin used in the column of approximately 1.0 gram. The concentration of Ge-68 in the inlet solution is specified as Ge equals 5 mCi per 10 mL, with the concentration of HCl in the solution maintained at 0.05 M and a flow rate of 1 mL per minute. In some preferred embodiments, the amount of Ge-68 solution passed through the column is 10 mL, and the amount of rinsing solution using 0.05 M HCl is also 10 mL, providing standardized conditions for evaluating the dynamic adsorption performance of the TSN-600 composite material. The data in Table 6 demonstrates that the germanium Ge-68 retained in the column is approximately 100 percent, confirming the effectiveness of the tin-doped titanium composite for selective germanium retention under dynamic flow conditions. In another preferred embodiment, the elution solution using 0.05 M HCl is 10 mL, with the volume of eluate collected in each time being 1 mL, enabling fractionated collection of the gallium-containing eluate for radiopharmaceutical applications.

The performance metrics presented in Table 6 of FIG. 10G demonstrate the suitability of the TSN-600 composite resin for Ge-68/Ga-68 radionuclide generator applications where selective germanium retention and efficient gallium elution are required. In a preferred embodiment, the Ge-68 breakthrough is listed as 1.2 times 10 to the negative sixth percent, indicating that the TSN-600 resin provides highly effective retention of the parent radionuclide with minimal leakage into the eluate stream during the elution process. The total amount of Ga released from the column at the outlet is approximately 75 percent, demonstrating that the composite material allows efficient elution of the daughter Ga-68 radionuclide while maintaining selective retention of the parent Ge-68 on the resin bed. In some preferred embodiments, the combination of high germanium retention and efficient gallium elution observed in Table 6 confirms that the TSN-600 composite material exhibits the selective adsorption characteristics desired for generator applications where radionuclidic purity of the Ga-68 product is required. The comparison of the Ge-68 breakthrough values between Table 5 and Table 6 indicates that the TSN-600 resin exhibits lower germanium breakthrough than the BMS-600 resin, with values of 1.2 times 10 to the negative sixth percent versus 3.0 times 10 to the negative fourth percent respectively. In another preferred embodiment, the experimental data presented in Table 6 supports the use of the mesoporous titanium-based composite material comprising a titanium dioxide matrix with a metal dopant comprising tin dispersed within the titanium dioxide matrix for selective germanium removal from aqueous solutions in radionuclide generator configurations.

A number of implementations have been described. Nevertheless, it will be understood that various modifications may be made without departing from the spirit and scope of the disclosure. Accordingly, other implementations are within the scope of the follow. The implementations set forth in the foregoing description do not represent all implementations consistent with the subject matter described herein but are examples consistent with the disclosed subject matter. Although variations have been described in detail above, other modifications or additions may be possible. In particular, further features and/or variations may be provided in addition to those set forth herein. For example, the implementations described above may be directed to various combinations and subcombinations of the disclosed features and/or combinations and subcombinations of several further features disclosed above. This does not constitute a departure from the inventive subject matter described herein.

1. A mesoporous boron-based composite material for selective germanium removal from aqueous solutions, comprising:
a boron-containing matrix derived from boric acid;
a nitrogen-containing component derived from melamine incorporated into the boron-containing matrix; and
a metal dopant comprising tin dispersed within the boron-containing matrix,
wherein the composite material exhibits selective adsorption of germanium over gallium from acidic aqueous solutions.

2. The mesoporous boron-based composite material of claim 1, wherein the composite material is calcined at a temperature ranging from 500° C. to 600° C.

3. The mesoporous boron-based composite material of claim 2, wherein the composite material is calcined at approximately 600° C. for approximately four hours under a nitrogen environment.

4. The mesoporous boron-based composite material of claim 1, wherein the tin is derived from stannous chloride.

5. The mesoporous boron-based composite material of claim 1, further comprising a surfactant template derived from a triblock copolymer.

6. The mesoporous boron-based composite material of claim 5, wherein the triblock copolymer comprises Pluronic-123.

7. The mesoporous boron-based composite material of claim 1, wherein the composite material exhibits a germanium uptake capacity of at least 1.0 mg Ge per gram of composite material from a 0.05 M hydrochloric acid solution.

8. The mesoporous boron-based composite material of claim 7, wherein the composite material exhibits substantially no gallium uptake from a binary mixture of germanium and gallium in the 0.05 M hydrochloric acid solution.

9. The mesoporous boron-based composite material of claim 1, wherein a molar ratio of boric acid to melamine to tin chloride (SnCl2) in the composite material is approximately 0.015:7.54×10-3:0.045.

10. A method of preparing a mesoporous boron-based composite material for selective germanium removal, comprising:
dissolving a surfactant in deionized water to form a surfactant solution;
adding boric acid to the surfactant solution under stirring;
preparing a melamine solution separately;
combining the melamine solution with the boric acid-surfactant solution and heating the combined mixture to form a gel;
drying the gel to form a dried gel; and
calcining the dried gel at a temperature of at least 500° C. to obtain the mesoporous boron-based composite material.

11. The method of claim 10, further comprising adding a metal dopant to the combined mixture prior to forming the gel.

12. The method of claim 11, wherein the metal dopant comprises tin derived from stannous chloride.

13. The method of claim 12, wherein adding the metal dopant comprises:
preparing a separate mixture of the surfactant, deionized water, and stannous chloride; and
combining the separate mixture with the boric acid-surfactant solution and the melamine solution.

14. The method of claim 10, wherein the surfactant comprises a triblock copolymer Pluronic-123.

15. The method of claim 10, wherein calcining the dried gel comprises heating at a temperature ranging from 500° C. to 600° C. for approximately four hours under a nitrogen environment.

16. The method of claim 15, further comprising an intermediate heating step of heating the dried gel at approximately 200° C. for approximately four hours prior to calcining at the temperature ranging from 500° C. to 600° C.

17. A method of selectively removing germanium from an aqueous solution containing germanium and gallium, comprising:
contacting the aqueous solution with a mesoporous boron-based composite material comprising a boron-containing matrix, a nitrogen-containing component derived from melamine, and a tin dopant;
adsorbing germanium onto the mesoporous boron-based composite material while gallium remains substantially in the aqueous solution; and
separating the aqueous solution from the mesoporous boron-based composite material to obtain a germanium-depleted solution.

18. The method of claim 17, wherein the aqueous solution comprises a 0.05 M hydrochloric acid solution.

19. The method of claim 18, wherein the mesoporous boron-based composite material is calcined at a temperature ranging from 500° C. to 600° C. under a nitrogen environment.

20. The method of claim 19, wherein the mesoporous boron-based composite material exhibits a germanium uptake capacity of at least 1.0 mg Ge per gram of composite material while exhibiting substantially no gallium uptake from the aqueous solution.
